(19) United States
(12) Patent Application Publication
(10) Pub. No.: US 2026/0257379 A1
(43) Pub. Date: Sep. 3, 2026

(54) ROBOTIC VACUUM GRIPPER WITH INTEGRATED FORCE-SENSING

(71) Applicant: Berkshire Grey Operating Company, Inc., Bedford, MA (US)

(72) Inventors: Bretton ANDERSON, Westford, MA (US); Jeffrey Ian LIPTON, Sharon, MA (US); Alexander Anthony JENKO, Medford, MA (US); William Chu-Hyon MCMAHAN, North Cambridge, MA (US); Evan BATTERMAN, Merrimack, MA (US); Jui-te LIN, Medford, MA (US)

(21) Appl. No.: 19/457,854

(22) Filed: Jan. 23, 2026

Related U.S. Application Data
(60) Provisional application No. 63/833,874, filed on Jan. 24, 2025.

(51) Int. Cl. B25J 15/06; B25J 13/08; B65G 47/91

(52) U.S. Cl. CPC B25J 15/0616; B25J 13/085; B65G 47/917

(57) ABSTRACT

A robotic end-effector for vacuum-based object handling is disclosed, incorporating integrated force sensing for accurate weight measurement at the point of grasp. The end-effector includes at least one vacuum cup mounted on a first portion that moves axially relative to a second portion attached to a robotic arm. A vacuum chamber is maintained at substantially constant volume and pressure during operation, isolating weight measurements from disturbances caused by vacuum dynamics or arm motion. Force sensors positioned in the load path enable detection of object mass, torque, and/or center of gravity. Embodiments include rolling diaphragms, pressure-balanced bellows, flange-based designs with multiple load cells, or array-based sets of vacuum cups. The system may operate with high-flow vacuum and provide force sensing, improving throughput and reducing mis-picks in automated pick-and-place environments.

### PRIORITY

This application claims priority to U.S. Provisional Patent Application No. 63/833,874 filed Jan. 24, 2025, the disclosure of which is hereby incorporated by reference in its entirety

### BACKGROUND

The invention generally relates to programmable motion systems and particularly relates to end-effectors for programmable motion devices (e.g., robotic systems) for use in object processing such as object sortation where an object is robotically picked from one location and placed in another.

Systems employing various aspects of the invention may be used, for example, in connection with robotic pick-and-place operations, particularly for high-throughput e-commerce, warehouse automation, and supply chain fulfillment environments. In these contexts, accuracy and throughput are paramount. Robotic grippers must handle a wide variety of SKUs, detect pick failures instantly, and operate in environments with minimal downtime. Mis-picks, multiple picks, and misidentified items result in costly delays, customer returns, and increased labor overhead.

End of arm tools, or end-effectors for robotic systems, for example, may be employed in certain applications to select and grasp an object, and then move the acquired object very quickly to a new location. End-effectors are designed to securely grasp an object so that it is held in a controlled manner as the object is rapidly moved from one location to another. Often, vacuum pressure is used for acquiring and securing object for transport and/or subsequent operations by the articulated arms of the programmable motion devices. In many applications, end-effectors on programmable motion devices must accommodate objects of many shapes, sizes, materials, and mass and an end-effector is often expected to exhibit the capability of accurately grasping a wide variety of objects.

Various sensors are provided on the programmable motion device to guide and control the robotic process of picking and placing objects. Verification of robotic object processing is commonly performed through processing of signals from the various sensors, including perception data from vision sensors and signals from strategically placed force/torque sensors. The signals from the various sensors, however, are typically remote from the end-effector and the actual object being grasped, and thus, the accuracy, precision, and reliability of such signals, is accordingly compromised.

There remains a need for an end-effector in a programmable motion system that may select and grasp any of a wide variety of objects, and reliably measure the mass of the grasped object without interference from the end-effector, the programmable motion device, and ancillary equipment.

### SUMMARY

In an aspect of the invention, a force sensing end-effector is provided with a first portion connected to a vacuum cup that is movable axially with respect to a second portion that is coupled to a programmable motion device and through which a vacuum is provided in a vacuum chamber that is maintained at a substantially constant vacuum volume irrespective of movement of the first portion with respect to the second portion, and at least one force sensor that is positioned to be impacted by movement of the first portion with respect to the second portion and to provide information relating to a force on the first portion with respect to the second portion.

In another aspect, a force sensing end-effector is provided with a first portion coupled to at least one vacuum cup and a second portion coupled to a programmable motion device, a central passage extending through the second portion to the first portion and fluidically connectable to a vacuum source for delivering vacuum to at least one vacuum cup, and at least one force sensor disposed between the first portion and the second portion, wherein the at least one force sensor is adapted to provide information relating to force on the first portion relative the second portion.

In yet another aspect, a torque sensing end-effector is provided with a first portion coupled to at least one vacuum cup that is movable axially with respect to a second portion that is coupled to a programmable motion device and through which a vacuum is provided to the at least one vacuum cup via a vacuum passage, a plurality of force sensors that are positioned around the vacuum passage, the plurality of force sensors being adapted to provide information relating to applied torque on the first portion relative the second portion.

### BRIEF DESCRIPTION OF THE DRAWINGS

The following description may be further understood with reference to the accompanying drawings in which:

FIG. 1 shows an illustrative diagrammatic view of an object processing system including a programmable motion device with an end-effector in accordance with an aspect of the present invention that includes an integrated mass detection sensor that includes rolling diaphragms.

FIG. 2 shows an illustrative diagrammatic overhead view of the object processing system of FIG. 1;

FIG. 3 shows an illustrative diagrammatic front elevational enlarged view of the programmable motion device of the object processing system of FIG. 1 grasping an object;

FIG. 4 shows an illustrative diagrammatic rear elevational enlarged view of the programmable motion device of FIG. 3 grasping the object;

FIG. 5 shows an illustrative diagrammatic exploded assembly view of the end-effector of FIG. 1;

FIGS. 6A and 6B show illustrative diagrammatic partial cutaway views of the end-effector of FIG. 1 with FIG. 6A showing the end-effector in a loaded position and FIG. 6B showing the end-effector in a retracted position, both while grasping an object;

FIGS. 7A and 7B show illustrative diagrammatic further partial cutaway views of the end-effector of the present invention with FIG. 7A showing the end-effector in a loaded position and FIG. 7B showing the end-effector in a retracted position;

FIGS. 7C and 7D show illustrative diagrammatic partial enlarged cutaway views of housing and central shaft interfaces in accordance with further aspects of the invention, showing the use of a wiper seal (FIG. 7C) and no seal, gasket or diaphragm (FIG. 7D);

FIGS. 8A and 8B show illustrative diagrammatic enlarged views of the end-effector of the present invention in a retracted position (FIG. 8A), and in an extended position (FIG. 8B);

FIG. 9 shows an illustrative diagrammatic view of the arrangement of a force sensor according to an aspect of the present invention;

FIG. 10 shows an illustrative diagrammatic view of an optional clutch mechanism within the end-effector according to an aspect of the present invention;

FIG. 11 shows an illustrative diagrammatic view of an object processing system including a programmable motion device with an end-effector in accordance with an aspect of the present invention that includes an integrated mass detection sensor that includes in-line pressure-balanced bellows;

FIG. 12 shows an illustrative diagrammatic front elevational enlarged view of the programmable motion device of the object processing system of FIG. 11 grasping an object;

FIG. 13 shows an illustrative diagrammatic rear elevational enlarged view of the programmable motion device of FIG. 12 grasping the object;

FIG. 14 shows an illustrative diagrammatic exploded assembly view of the end-effector of FIG. 11;

FIGS. 15A and 15B show an illustrative diagrammatic view of the end-effector of FIG. 11 with FIG. 15A showing the end-effector in a loaded position and FIG. 15B showing the end-effector in a retracted position, both while grasping an object;

FIG. 16 shows an illustrative diagrammatic elevated view of the force sensing system of the force-sensing end-effector of FIG. 11 with the force sensor not being contacted;

FIG. 17 shows an illustrative diagrammatic underside view of the force sensing system of FIG. 16 with the force sensor not being contacted;

FIG. 18 shows an illustrative diagrammatic elevated view of the force sensing system of the weight-sensing end-effector of FIG. 11 with the force sensor being contacted;

FIG. 19 shows an illustrative diagrammatic underside view of the force sensing system of FIG. 18 with the force sensor being contacted;

FIG. 20 shows an illustrative diagrammatic view of an object processing system including a programmable motion device with an end-effector in accordance with an aspect of the present invention that includes an integrated force detection system with multiple force sensors;

FIG. 21 shows an illustrative diagrammatic front elevational enlarged view of the programmable motion device of the object processing system of FIG. 20 grasping an object;

FIG. 22 shows an illustrative diagrammatic rear elevational enlarged view of the programmable motion device of the object processing system of FIG. 20 grasping an object;

FIG. 23 shows an illustrative diagrammatic exploded assembly view of the end-effector of FIG. 20;

FIG. 24 shows a detailed illustrative diagrammatic exploded partial assembly view of the end-effector of FIG. 23;

FIG. 25 shows a further detailed illustrative diagrammatic exploded partial assembly view of the end-effector of FIG. 24;

FIG. 26 shows an illustrative diagrammatic view of the end-effector of FIG. 20;

FIG. 27 shows an illustrative diagrammatic view of the end-effector of FIG. 26 with a protective shroud installed;

FIG. 28 shows an illustrative diagrammatic elevational view of the end-effector of FIG. 20;

FIG. 29 shows an illustrative diagrammatic elevational view of an end-effector in accordance with a further aspect of the invention that includes a compliant split-tube;

FIG. 30 shows an illustrative diagrammatic elevated view of the end-effector of FIG. 29;

FIG. 31 shows an illustrative diagrammatic side view of the end-effector of FIG. 29 with a protective cover around the compliant split-tube;

FIG. 32 shows an illustrative diagrammatic elevational view of an end-effector in accordance with a further aspect of the invention that includes an elastic material (shown without the flange housing);

FIG. 33 shows an illustrative diagrammatic elevational view of the end-effector of FIG. 32 shown with the flange housing;

FIG. 34 shows an illustrative diagrammatic elevated view of the end-effector of FIG. 32;

FIG. 35 shows an illustrative diagrammatic side view of the end-effector of FIG. 32 with a protective cover around the elastic (spring) material;

FIG. 36 shows an illustrative diagrammatic cut-away view of an end-effector in accordance with a further aspect of the present invention that includes a multidirectional gap;

FIG. 37 shows an illustrative photographic representation of the end-effector of FIG. 36;

FIG. 38 shows an illustrative diagrammatic assembled view of the end-effector of FIG. 36;

FIG. 39 shows an illustrative diagrammatic exploded view of the end-effector of FIG. 36;

FIG. 40 shows an illustrative diagrammatic view of the end-effector of FIG. 36 with a protective housing around the force sensors;

FIG. 41 shows an illustrative photographic view of a test apparatus for use in connection with end-effectors of various aspects of the present invention;

FIG. 42 shows an illustrative graphical representation of pressure calibration using plural tests;

FIG. 43 shows an illustrative graphical representation of pressure calibration showing the experimental results and a curve fit;

FIG. 44 shows an illustrative diagrammatic view of an object processing system including a programmable motion device with an end-effector in accordance with an aspect of the present invention that includes an array-based integrated mass detection sensor;

FIG. 45 shows an illustrative diagrammatic front elevational enlarged view of the programmable motion device of the object processing system of FIG. 44 moving to grasp an object;

FIG. 46 shows an illustrative diagrammatic rear elevational enlarged view of the programmable motion device of the object processing system of FIG. 45 moving to grasp an object;

FIG. 47 shows an illustrative diagrammatic exploded assembly view of the end-effector of FIG. 44;

FIG. 48 shows an illustrative diagrammatic exploded assembly view of a portion of the end effector of FIG. 44;

FIG. 49 shows an illustrative diagrammatic operational view of the end-effector of FIG. 44 from a lower perspective;

FIG. 50 shows an illustrative diagrammatic partial cut-away operational view of the end-effector of FIG. 44;

FIG. 51 shows an illustrative diagrammatic view of an object processing system including a programmable motion device with an end-effector in accordance with an aspect of the present invention that includes an alternative array-based integrated mass detection sensor;

FIG. 52 shows an illustrative diagrammatic front elevational enlarged view of the programmable motion device of the object processing system of FIG. 51 moving to grasp an object;

FIG. 53 shows an illustrative diagrammatic rear elevational enlarged view of the programmable motion device of the object processing system of FIG. 52 moving to grasp an object;

FIG. 54 shows an illustrative diagrammatic exploded assembly view of the end-effector of FIG. 51;

FIG. 55 shows an enlarged illustrative diagrammatic view of a portion of the end-effector of FIG. 51;

FIG. 56 shows an enlarged illustrative diagrammatic view of the portion of the end-effector of FIG. 55 from a different perspective;

FIG. 57 shows a partial cutaway illustrative diagrammatic view of the end-effector shown in FIG. 56;

FIG. 58 shows a detailed enlarged diagrammatic view of the elements providing a force sensing capability of the end-effector of FIG. 51;

FIG. 59 shows an illustrative diagrammatic operational view of the end-effector of FIG. 51 from a lower perspective; and

FIG. 60 shows an alternative illustrative diagrammatic operational view of the end-effector of FIG. 51 from a different perspective.

The drawings are shown for illustrative purposes.

### DETAILED DESCRIPTION

In accordance with various aspects, the invention provides an end-effector system for programmable motion devices (e.g., robotic systems) that provides high flow vacuum to grasp objects of widely varying sizes, shapes, materials and mass. The high flow vacuum is provided at an end-effector vacuum applicator of the robotic system, and the vacuum applicator is coupled to a high flow vacuum system. The vacuum applicator is attached to an applicator attachment portion, which is in turn attached to an arm attachment portion that is attached to an articulated arm of the robotic system. The vacuum applicator may be a vacuum cup that is formed of a flexible cup bellows.

When grasping and moving objects from one location to another, the throughput of the system is negatively impacted by missed picks (where the object is not grasped by the vacuum applicator), inadvertent multiple picks (where more than one object is picked when only one is intended), and incorrect picks (where the wrong item is picked). The negative impact on throughput is the result of wasted time of the system identifying the problem and correcting the problem, and the further down the process the problem is identified, the more costly becomes the impact on throughput.

The ability to establish the weight, or mass, of the grasped object at the moment the item is grasped, is important to identify any one of missed picks, inadvertent multiple picks, and incorrect picks as quickly as possible. Once grasped, an accurate assessment of the object mass can determine if the object was actually picked. With the mass of the object known with reference to an object database using the object stock keeping unit, an accurate assessment of the grasped object mass can be used to verify that the correct object was picked, or if an inadvertent multiple pick was made.

A common challenge with determining the mass of a grasped object on a vacuum applicator of a robotic system is the mechanical disturbances caused by the operation of the robotic system and associated vacuum supply. Sensors commonly placed in the joints of the robotic system may be commonly used to determine the force (or torque) applied to the cantilevered arm of a programmable motion device and monitoring that signal can provide indications of the mass associated with a grasped object. The accuracy of such a signal, however, is typically compromised, particularly with high flow vacuum, when the vacuum supply hose supplied to the vacuum applicator of the robotic system contributes noise to the force/torque signals when operating. This problem is compounded by mechanical disturbances caused by the operation of the high flow vacuum system, such as when the pressure changes when an object is grasped, or when the vacuum is turned on and off to grasp or eject the object. The vacuum hose to the programmable motion device will change tension during operation, and as the robotic arm extends or retracts over a workspace, the forces induced upon the vacuum applicator of the robotic system will be dynamic.

In some systems, where grasping pressure may be variable, such as high flow vacuum systems that are able to effectively grasp objects despite leaks in the vacuum connections and related apparatus, mechanical forces applied to the vacuum applicator of the robotic device may further change during operation. These dynamic forces applied to the portion of the programmable motion device that is performing the grasp of objects to be moved, introduce noise or errors in the force, e.g., weight, measurement, rendering the information supplied by typical systems to be unreliable for object verification and grasp verification.

A primary goal of certain systems of the invention, therefore, is to provide a force measurement of an object being grasped, while minimizing adverse impacts of forces that are applied to the end-effector system such as by the vacuum hose system. This is achieved in accordance with certain aspects by permitting a vacuum cup that grasps the object to be free to drop or hang against a force sensor in either compression or tension. In accordance with various aspects, one, two, three, four or more force sensors may be used, and the outputs of the force sensors disclosed herein provide information of a force on each force sensor, for example from movement of a first portion with respect to a second portion of the force sensing end-effector. Such freedom of movement of a vacuum cup however, presents other challenges of maintaining proper vacuum pressure.

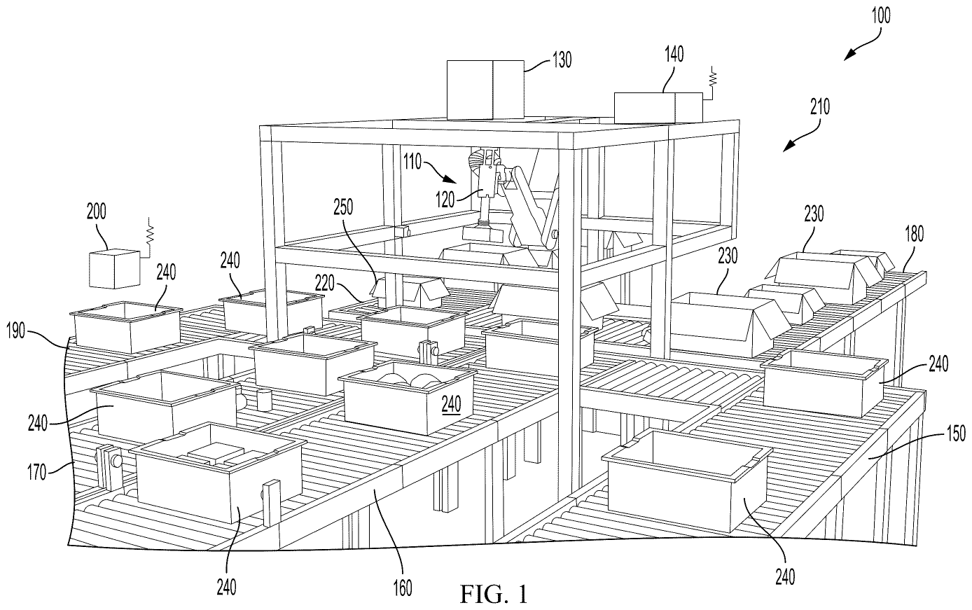

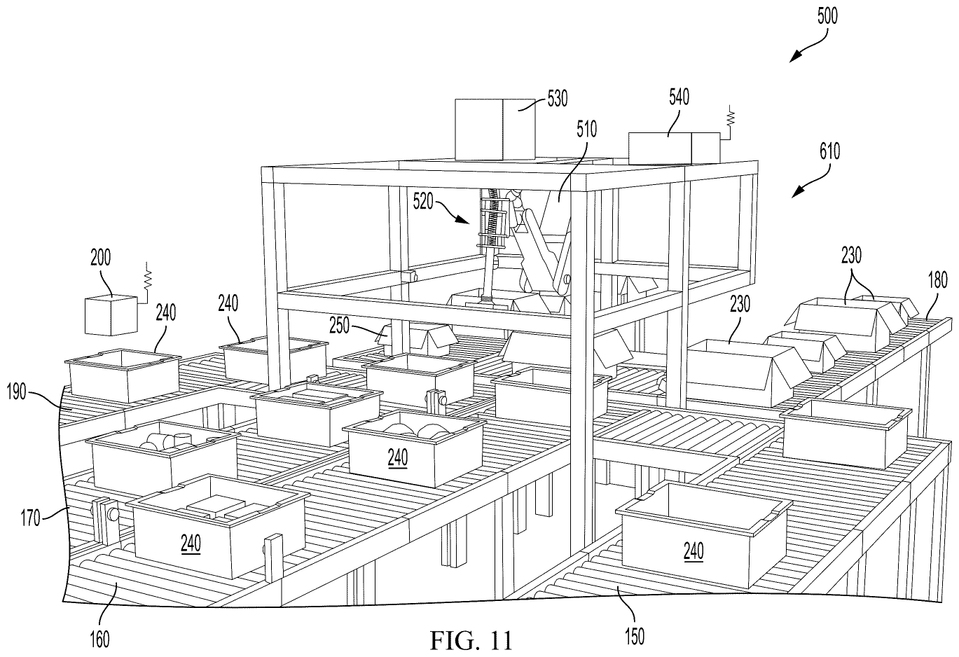

In the examples of FIGS. 1-10, the grasping force on a grasped object is maintained by using rolling diaphragms that move to accommodate the movement of the vacuum cup and associated vacuum shaft while maintaining appropriate vacuum pressure on the object being grasped. In the examples of FIGS. 11-19, the grasping force on a grasped object is maintained by using in-line pressure balanced bellows that similarly move to accommodate the movement of the vacuum cup and associated vacuum shaft while maintaining appropriate vacuum pressure on the object being grasped.

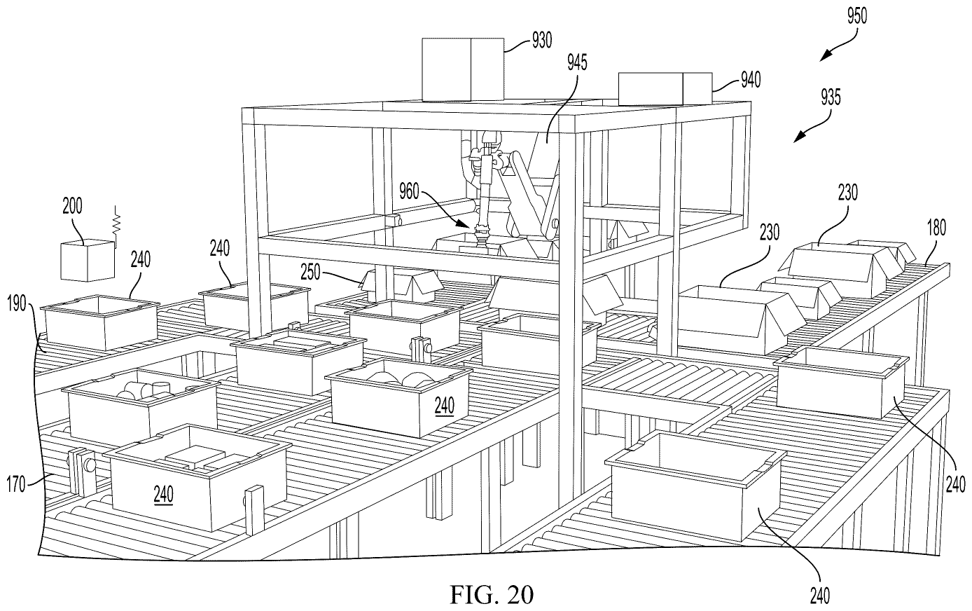

In the examples of FIGS. 20-40, the sensing is achieved very close to the vacuum cup on the outside of the vacuum channel, so no pressure balancing is required. A force-sensing test apparatus may be employed to establish any baseline adjustments that are required.

With reference to FIG. 1, an object processing system 100 in accordance with an aspect of the present invention includes an object processing station 210 with a programmable motion device 110 that grasps and moves objects with a force sensing end-effector 120 that provides an accurate and reliable assessment of the mass of the grasped object despite external influences. The operation of the programmable motion device 110 at object processing station 210 is controlled by controller 140 in cooperation with the system controller 200 of the object processing system 100. The force sensing end-effector 120 uses vacuum to grasp objects with the vacuum supplied by a high flow vacuum source 130. The high flow vacuum source 130 may, for example, provide an air flow of at least about 100 cubic feet per minute, and a vacuum pressure of no more than about 100,000 Pascals below atmospheric, or no more than about 85,000 Pascals below atmospheric, or no more than about 65,000 or 50,000 Pascals below atmospheric.

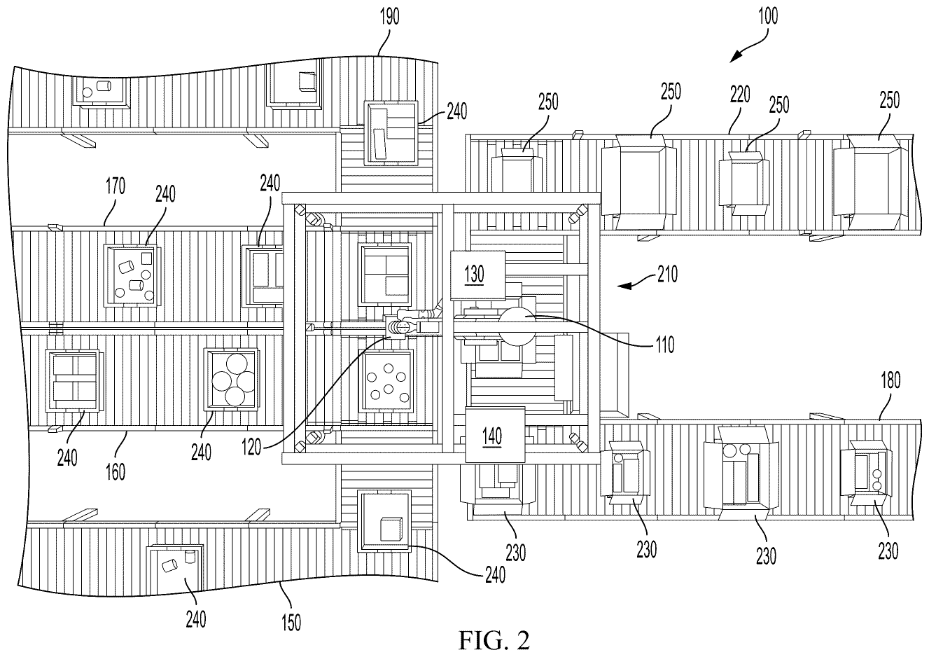

In accordance with various aspects, objects to be processed may be provided to the programmable motion device 110 at the object processing station 210 in inventory bins 240 to be placed in completed containers 230. Inventory bins 240 are brought into the object processing station 210 from storage or previous processing on inventory input conveyor 160 and inventory input conveyor 170. Once objects are picked from the respective inventory bin 240, the inventory bins 240 are returned to storage or further processing on inventory output conveyor 150 or inventory output conveyor 190. With continued reference to FIG. 1 and with reference to FIG. 2, the output of the object processing station 210 are shown as completed order boxes 230 that leave the object processing station 210 on output conveyor 180. Empty order boxes 250 are supplied to the object processing station 210 on input conveyor 220. As such, the illustrative operation of the programmable motion device 110 with the force sensing end-effector 120 is demonstrated as picking an object from an inventory bin 240 and placing the object in an empty order box 250 to create a completed order box 230. Throughput of the object processing system 100 can be expressed as a number of items picked per unit time, such as picks/hour. Mis-picks, inadvertent multiple picks, and incorrect picks result in any of downtime, rework, or customer returns.

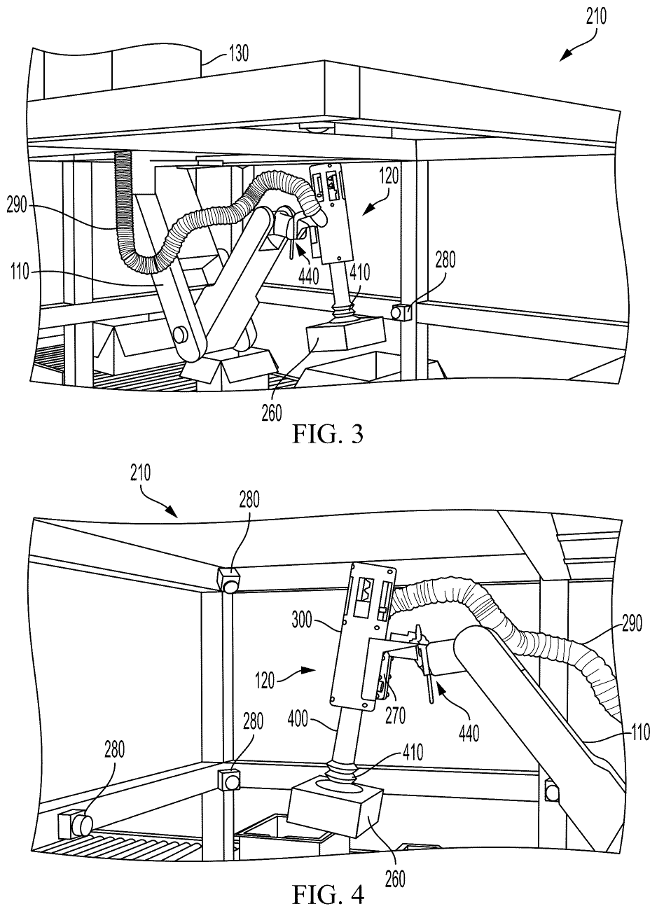

With reference to FIG. 3, the force sensing end-effector 120 is shown at object processing system 210, attached to programmable motion device 110 at the end-effector attachment point 440. The object processing system 210 includes perception systems 280 that provide guidance to the programmable motion device 110, visual verification, and object identification. As shown in FIG. 3, the high flow vacuum source 130 provides vacuum to the force sensing end-effector 120 through vacuum hose 290. The programmable motion device 110 is shown in a lifted position in that force sensing end-effector 120 is grasping for movement an object 260. In this lifted position, it is clear that the vacuum hose 290 will induce tension on the programmable motion device 110 if it were conventionally attached. As will more clearly be described herein below with reference to FIGS. 4-7D, the force sensing end-effector 120 isolates the force sensing function from any deflections applied to the programmable motion device 110, whether from movement of the programmable motion device 110 or dynamic forces induced by the vacuum hose as the grasp becomes effective causing the vacuum pressure to change and vacuum flow to drop.

FIG. 4 depicts a rear view of the programmable motion device 110 showing the mounting apparatus 270 that couples a housing 300 of the end-effector to the programmable motion device. A central shaft 400 is axially movable within the housing 300, and a vacuum cup 410 is attached to the distal end of the central shaft 400. As the articulated arm of the programmable motion device 110 is extended, the vacuum hose 290 will also be extended, which will impact the dynamic forces applied to the programmable motion device 110, particularly at the end-effector joint 440, where typical force measurements are made to establish the force of the picked item. As will be described in further detail below, the force sensing end-effector 120 isolates the force sensing function of the end-effector from the programmable motion device 110 and the ancillary equipment to provide an accurate and reliable assessment of the weight of the object grasped.

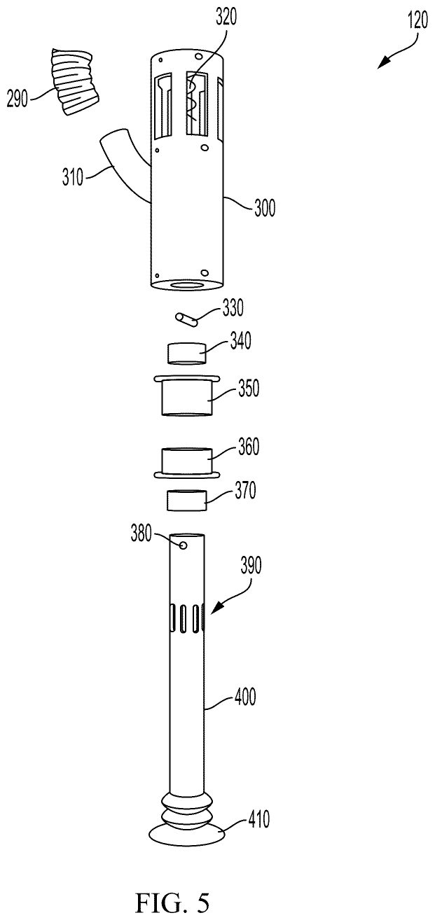

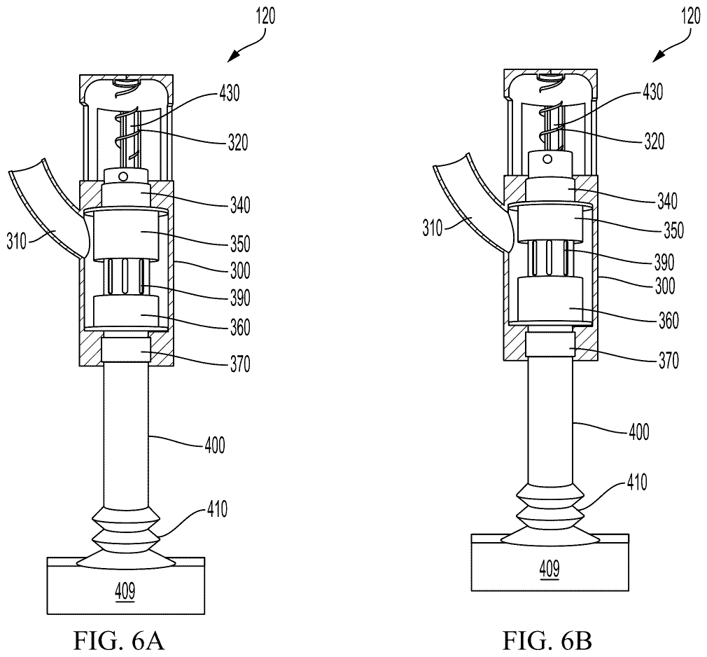

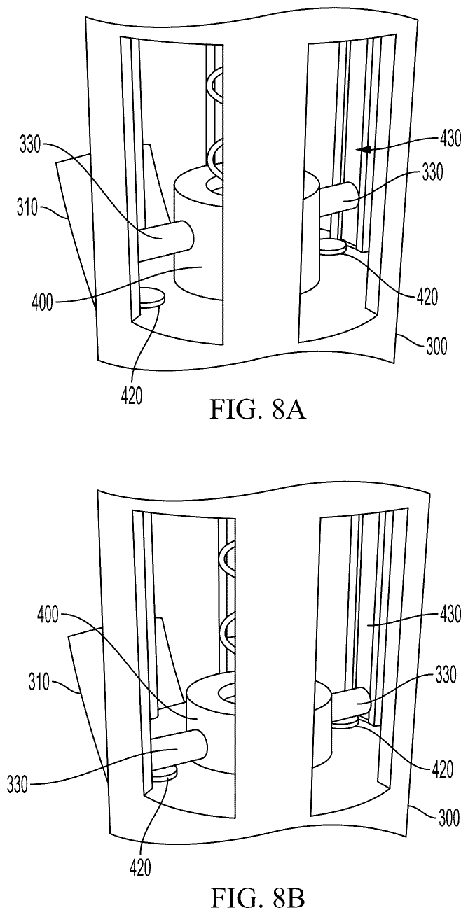

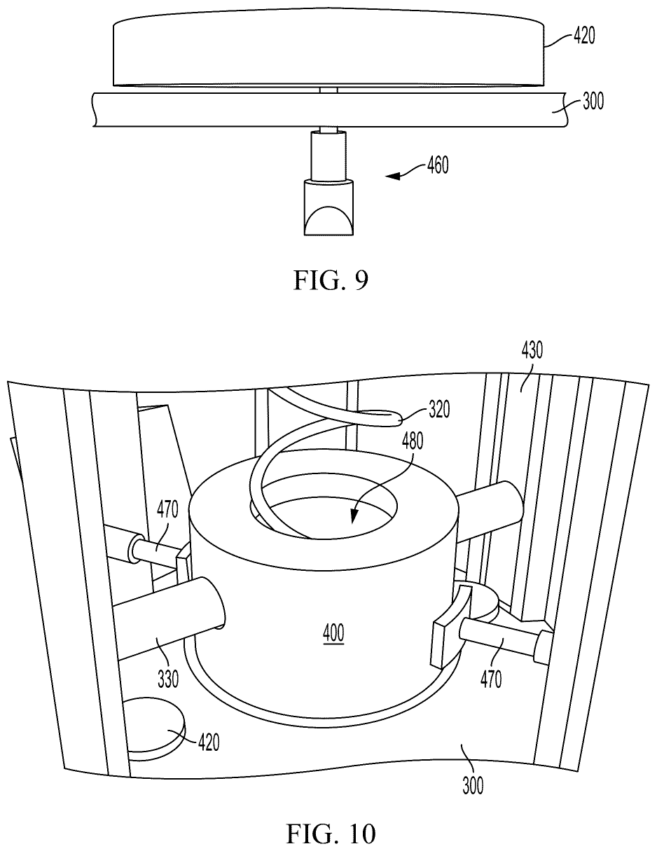

FIG. 5 shows an exploded view of components of the force sensing end-effector 120. The housing 300 includes the necessary attachment mechanism (470 shown in FIG. 4) to the end-effector joint 440 of the programmable motion device 110. The housing 300 includes a vacuum port 310 into which the vacuum hose 290 is attached. The housing 300 includes a central bore and a hollow chamber (shown in further detail below with reference to FIGS. 6A and 6B) into which the central shaft 400 is inserted. The compliant vacuum cup 410 is provided on the distal end of the central shaft 400. The central shaft has a central bore that extends from the vacuum ports 390 through the distal end of the central shaft 400 at the vacuum cup 410. The proximal end of the central shaft is solid. Elements of the force sensing end-effector 120 include a cross pin 330 that fits in cross pin hole 380, upper bearing 340 (such as a plain bearing or a roller bearing), upper diaphragm seal 350, lower diaphragm seal 360, and lower bearing 370 (such as a plain bearing or a roller bearing). In operation, the central shaft is acted upon by the mass of a grasped object, which provides a downward force on the central shaft 400 relative to the housing 300. Force sensor contacts 420 (such as contacts of load cells or force torque sensors shown in FIGS. 8A and 8B) are in contact with the cross pin 330 and the downward force on the central shaft 400 is directly measured by the force sensors to provide an assessment of the mass of the grasped object. FIG. 9 shows a side view of a force sensor 460 (e.g. a load cell) showing it's mounting on the annular surface of the housing 300.

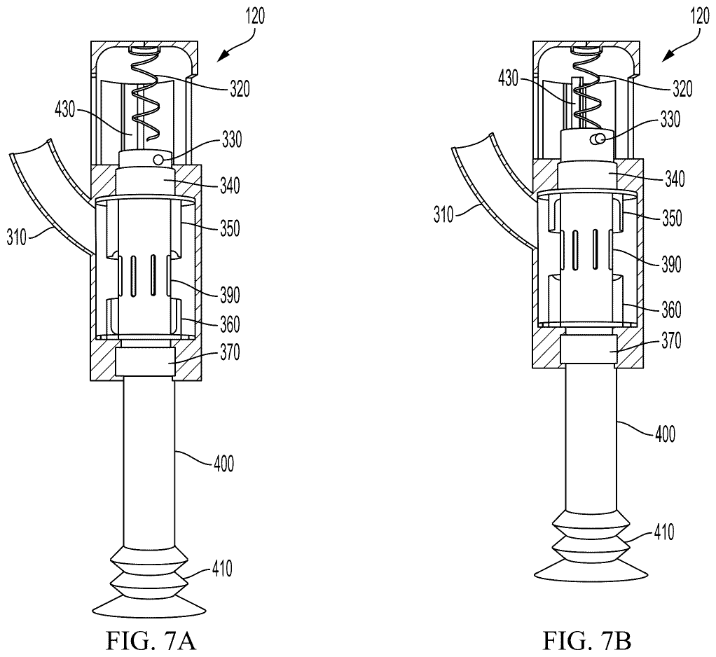

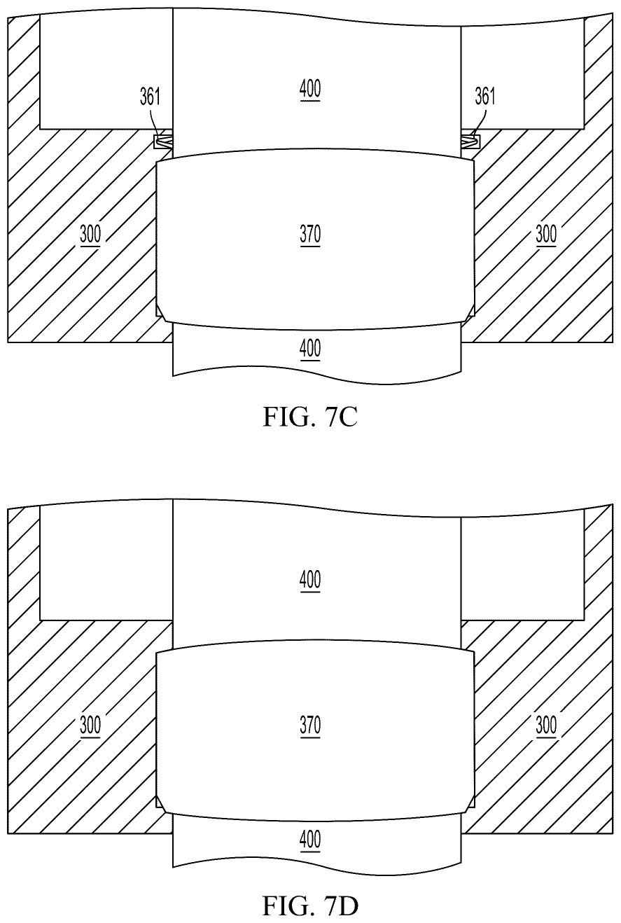

FIGS. 6A, 6B, 7A, and 7B show the force sensing end-effector 120 in various partial cutaway views to better describe the function of the essential components. FIG. 6A shows the force sensing end-effector 120 in a partial cutaway view in a loaded configuration grasping an object 409. The central shaft 400 is fully extended down relative to the housing 300. FIG. 6B shows the force sensing end-effector 120 in the same partial cutaway view as FIG. 6A but with the central shaft retracted, which may be expected when the programmable motion device 110 is picking or placing object 409 to provide a level of compliance in the z direction. The central shaft 400 is slidably positioned in the central bore of the housing 300 with the cross pin 330 inserted in the cross-pin hole 380 (not shown) with the cross pin 330 captured in a slot 430 on opposing sides (as more clearly depicted in FIGS. 8A and 8B). The central shaft 400 is slidably supported by the lower bearing 370 and the upper bearing 340, with both the upper bearing 340 and the lower bearing 370 press fit or otherwise secured within the housing 300. The upper bearing 340 and the lower bearing 370 are selected to provide telescoping motion of the central shaft 400 within the central bore of the housing 300 to ensure smooth, frictionless operation without inducing drag, noise, or inaccuracies to load measurements on the central shaft 400.

The upper diaphragm seal 350 and the lower diaphragm seal 360, as shown in FIGS. 6A and 6B are each rolling rubber diaphragms that are sealed to the housing 300 on the outer extent and sealed to the central shaft 400 on the inner extent. In this way, the upper diaphragm seal 350 and the lower diaphragm seal 360 form a sealed vacuum chamber 450 that is open to the ports 390 in the central shaft 400 and open to the vacuum port 310 without causing any drag on the central shaft 400 as the central shaft 400 telescopes within the central bore of the housing 300. The upper diaphragm seal 350 and the lower diaphragm seal 360 are generally identical in size and shape but inverted relative to each other, and therefore counterbalance resistance forces, thereby ensuring no additional forces are transferred to the shaft in the form of resistance that would otherwise impact the accuracy of the force sensing end-effector 120.

FIG. 7A and FIG. 7B each show an alternate partial cutaway view of the force sensing end-effector 120 but with the upper diaphragm seal 350 and the lower diaphragm seal 360 also cut away to show how the diaphragms roll. In FIG. 7A, which is a loaded position of the central shaft 400 relative to the housing 300, the upper diaphragm seal 350 is in a normal position with the lower diaphragm seal in a contracted position. In FIG. 7B, which is a retracted position of the central shaft 400 relative to the housing 300, the upper diaphragm seal 350 is in a contracted position with the lower diaphragm seal in a normal position.

In accordance with further aspects of the invention, the rolling diaphragms may be replaced by O-rings or wiper seals. For example, FIG. 7C shows the lower bearing 370 mounted in the housing 300 and through which the central shaft 400 passes. As shown in FIG. 7C, the diaphragms may be replaced by O-rings or wiper seals 361. In accordance with yet further aspects, no diaphragms, O-rings or seals may be used, and the system may operate tolerating some loss of the high flow vacuum. FIG. 7D shows the lower bearing 370 mounted in the housing 300 and through which the central shaft 400 passes with no seal, gasket or diaphragm along the central shaft 400. Again, the system may operate tolerating some loss of the high flow vacuum through the small gap between the central shaft 400 and the housing 300. The above-described arrangements (with reference to FIGS. 7C and 7D) in connection with the lower bearing may respectively also be used in connection with the interface at the upper bearing 340.

A spring 320 is optionally provided to provide resistance to the central shaft 400 when it is being retracted during picks and/or placements of objects. The spring 230 preferably does not provide a preload on the central shaft 400 in the idle position, which would need to be offset computationally when assessing the mass of a grasped object. In accordance with certain aspects, however, the spring may provide a force on the central shaft when in the idle position, but in this case the force would be very consistent due to the consistency of the idle position.

FIG. 8A shows an enlarged view of the proximal end of the housing 300 where the central shaft 400 protrudes with the cross pin 330 affixed and captured in the pair of slots 330. FIG. 8A depicts the central shaft 400 in a retracted position, showing the position of the force sensor contacts 420 that are positioned for contact with the cross pin 330. FIG. 8B shows the same enlarged view of the upper end of the housing 300 shown in FIG. 8A, but with the central shaft in the idle or loaded position. Here, the shaft is fully extended so that the cross pin 330 is at the lower end of the slot 330 and in contact with, and applying a force, commensurate with the weight of any grasped object attached to the vacuum cup 410 at the distal end of the central shaft 400, with the force sensor contacts 420 of one force sensor or two force sensors (as shown).

FIG. 9 shows an enlarged side view of the force sensor contact 420 positioned above a portion of the housing 300 and the force sensor 460. When the force sensing end-effector 120 is idle, the cross pin 330 contacting the load cell or force torque sensor contact 420 applies a force detected by the force sensor that is commensurate with the weight of the central shaft 400 and the vacuum cup 410. Any movement or force applied to the force sensing end-effector 120 by the vacuum hose 290 or any forces applied to the housing 300 are not detected by the force sensor 460. When the force sensing end-effector 120 grasps an object by the vacuum cup 410, the additional forces applied to the load cell 460 are commensurate with the weight of the grasped item. Accordingly, the processor 140 and/or the system controller 200 can readily assess the mass of the grasped object once grasped to easily and accurately determine if an object is mis-picked, inadvertently multi-picked, or based on the known mass of the object, whether the correct item was picked.

FIG. 10 shows an enlarged view of optional features of the invention. Because the central shaft is free to telescope in a retracted position with little to no resistance, a brake or clutch 470 can be provided to lock the central shaft 400 into position during movement of the grasped object. For example, if the programmable motion device 110 has a path planned that includes acceleration in a downward motion, locking the central shaft 400 using the brake or clutch 470 may provide better control during movement, and in particular during downward acceleration during object placement. The brake or clutch 470 is shown as extending pads actuated using solenoid actuators, which are used to grasp or release the central shaft 400, or to provide a limited amount of friction during movement. The brake or clutch may be applied after a pick and may be released prior to placement of an object at a destination location. Additionally, as previously described, the spring 320 can be optionally provided to resist retraction, with the spring 320 shown engaged in a recess 480 of the closed end of the central shaft 400.

In accordance with an aspect, therefore, the invention provides a force sensing end-effector that includes a first portion (e.g., the central shaft) connected to a vacuum cup that is movable axially with respect to a second portion (e.g., the housing) that is coupled to a programmable motion device and through which a vacuum is provided in a vacuum chamber that is maintained at a substantially constant volume and pressure irrespective of external forces acting on the end-effector and irrespective of movement of the vacuum cup 410 and central shaft 400 moving relative the housing 300. The system includes at least one force sensor that is positioned to be impacted by movement of the central shaft 400 and vacuum cup 410 with respect to the housing 300. Note that due to the use of the cross-pin 330 that rides in the slot 430, the first portion is not able to rotate with respect to the second portion.

While the systems discussed herein include inventory bins on input conveyors and boxes on output conveyors, the force-sensing grippers of the embodiments and inventions disclosed herein may be used with a wide variety of object processing systems, including for example, systems that do not include any of bins or boxes. Such systems may pick objects from conveyors and/or may place objects into chutes or intermediate locations.

In certain aspects therefore, the vacuum chamber 450 is configured to maintain a substantially constant internal volume and pressure irrespective of relative movement between a first portion 400 and a second portion 300 while grasping an object 401. The vacuum chamber 450 may, for example, be bounded by upper and lower rolling diaphragms as discussed above with reference to FIGS. 1-10.

In accordance with further aspects, the chamber may be defined by plates that separate via in-line, pressure-balanced bellows units. This constant-volume architecture isolates vacuum-induced forces from a central tube and accommodates relative movement of the central shaft with respect to a housing so that one or more force sensors in the load path measure only the weight of the tube, suction cup, spring preload, and any item engaged by the gripper while grasping an object. As a result, the system provides more accurate determinations of the mass of the engaged item without reliance on complex fluid-dynamic models.

In particular, and in accordance with further aspects, the invention provides another force sensing end-effector that includes in-line pressure balanced bellows units. Similar to the system of FIG. 1, the object processing system 500 includes an object processing station 610 with a programmable motion device 510 that grasps and moves objects with a force sensing end-effector 520 that provides an accurate and reliable assessment of the mass of the grasped object despite external influences as shown in FIG. 10. The operation of the programmable motion device 510 at object processing station 610 is controlled by controller 540 in cooperation with the system controller 200 of the object processing system 500. The force sensing end-effector 520 uses vacuum to grasp objects with the vacuum supplied by a high flow vacuum source 530. Again, the high flow vacuum source 530 may, for example, provide an air flow of at least about 100 cubic feet per minute, and a vacuum pressure of no more than about 100,000 Pascals below atmospheric, or no more than about 85,000 Pascals below atmospheric, or no more than about 65,000 or 50,000 Pascals below atmospheric.

Similar to the system 100 of FIG. 1, objects to be processed are provided to the programmable motion device 510 at the object processing station 610 in inventory bins 240 to be placed in completed containers 230. Inventory bins 240 are brought into the object processing station 210 from storage or previous processing on inventory input conveyor 160 and inventory input conveyor 170. Once objects are picked from the respective inventory bin 240, the inventory bins 240 are returned to storage or further processing on inventory output conveyor 150 or inventory output conveyor 190. Completed order boxes 230 leave the object processing station 610 on output conveyor 180. Empty order boxes 250 are supplied to the object processing station 610 on input conveyor 220. As such, the illustrative operation of the programmable motion device 510 with the force sensing end-effector 520 is demonstrated as picking an object from an inventory bin 240 and placing the object in an empty order box 250 to create a completed order box 230. Throughput of the object processing system 500 can be expressed as a number of items picked per unit time, such as picks/hour. Mis-picks, inadvertent multiple picks, and incorrect picks result in any of downtime, rework, or customer returns.

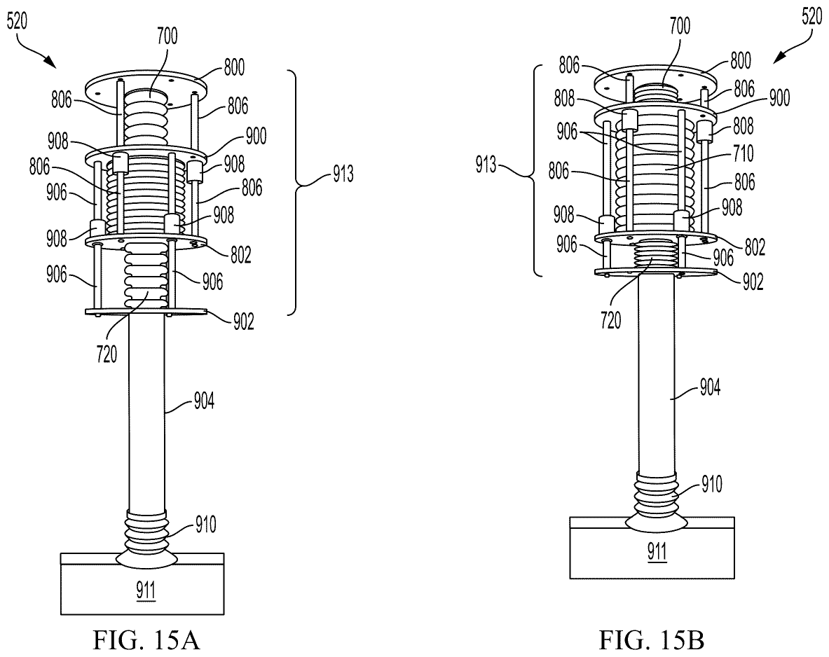

With reference to FIG. 12, the force sensing end-effector 520 is shown at object processing system 610, attached to programmable motion device 510 at the end-effector joint 840. Similarly, the object processing system 610 includes perception systems 680 that provide guidance to the programmable motion device 510, visual verification, and object identification. As shown in FIG. 12, the high flow vacuum source 530 provides vacuum to the force sensing end-effector 520 through vacuum hose 690. The programmable motion device 510 is shown in a lifted position in that force sensing end-effector 520 is grasping an object 660 for movement. In this lifted position, it is clear that the vacuum hose 690 will induce tension on the programmable motion device 510 if it were conventionally attached. As will be described below in further detail (with reference to FIGS. 15A and 15B, the force sensing end-effector 520 isolates the force sensing function from any deflections applied to the programmable motion device 510, whether from movement of the programmable motion device 510 or dynamic forces induced by the vacuum hose as the grasp becomes effective causing the vacuum pressure to change and vacuum flow to drop.

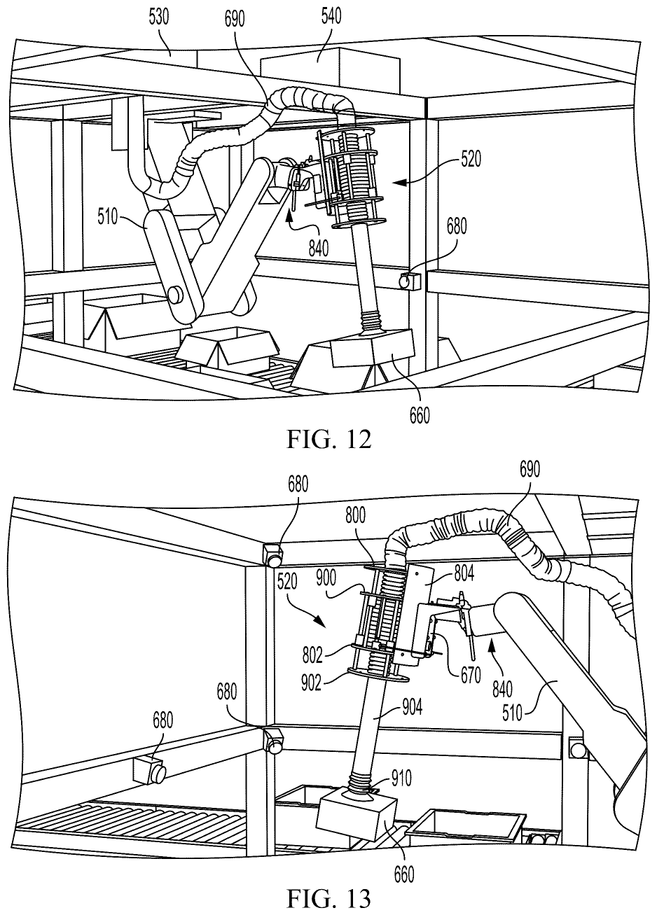

FIG. 13 shows a rear view of the programmable motion device 510 showing the mounting apparatus 670 that couples a mounting unit 804 of the end-effector 520 to the programmable motion device. As described in more detail below with reference to FIGS. 15A and 15B, the end-effector 520 includes a first portion that includes plates 900, 902 and shaft 904 that is coupled to a vacuum cup 910 (shown grasping an object 660), and a second portion that includes plates 800, 802 and mounting unit 804 for coupling to the programmable motion device 510 via mounting apparatus 670 and end-effector joint 840. The first portion is axially movable with respect to the second portion, at least when the force detection system is not attached thereto; in the end-effector 520 the force detection system inhibits significant movement between the first portion and the second portion.

As the articulated arm of the programmable motion device 510 is extended, the vacuum hose 690 will also be extended, which will impact the dynamic forces applied to the programmable motion device 510, particularly at the end-effector joint 840, where typical force measurements are made to establish the weight of the picked item. As will be described in further detail below with reference to FIGS. 15A and 15B, the force sensing end-effector 520 isolates the force sensing function of the end-effector from the programmable motion device 510 and the ancillary equipment to provide an accurate and reliable assessment of the weight of the object 911 as grasped.

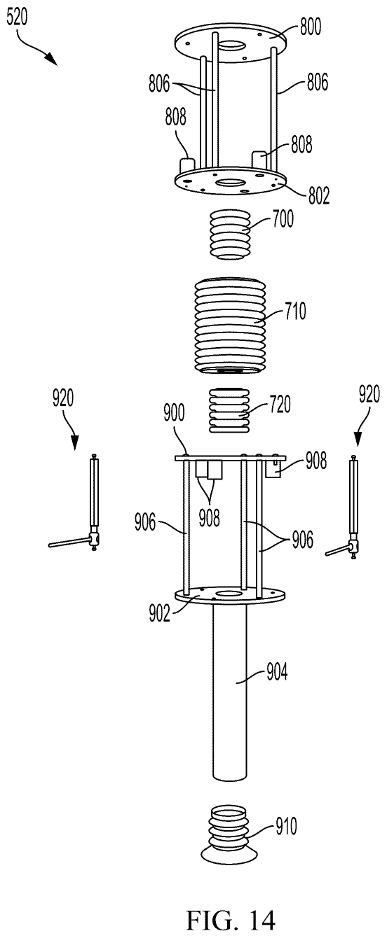

FIG. 14 shows an exploded view of components of the force sensing end-effector 520. The first portion (as noted above with reference to FIG. 13) includes the plates 900, 902 and shaft 904 that is coupled to a vacuum cup 910. The first portion also includes fixed rods 906 and alignment bearings 908. The second portion includes plates 800, 802 and the mounting unit 804 (shown in FIG. 13) that is coupled to the mounting apparatus 670 (also shown in FIG. 13). The second portion also includes fixed rods 806 and alignment bearings 808. As noted above with reference to FIG. 13, prior to attachment of the force detection systems 920, the first portion is freely moveable with respect to the second portion within a limited range of the rods 806, 906 as the plate 900 is captured proximally of the plate 802 when assembled. Each force detection system 920 is mounted between the plate 802 and the (more proximal) plate 900 when assembled.

FIGS. 15A and 15B show the end-effector 520 without the force detection systems 920 showing some of the freedom of movement of the first portion with respect the second portion as well as the expansion and collapsing of bellow units 700, 710, 720 that sit between plates 800, 900, 802, 902 respectively when assembled. In particular, FIG. 15A shows the end-effector 520 in an extended position with the bellows unit 700 extended between the plates 800 and 900 and the bellows unit 720 extended between the plates 802 and 902. The bellows unit 710 is thereby contracted between plates 900 and 802. Shaft 904 is coupled to the plate 902 and includes the vacuum cup 910 at the distal end thereof. The vacuum cup 910 and vacuum shaft 904 are permitted to freely move relative to the vacuum chamber assembly 913. With reference to FIG. 15B, when the vacuum cup 910 and shaft 904 are moved axially in a proximal direction, the rods 806 move freely within the bearings 908 and the rods 908 move freely within the bearings 808. FIG. 15B shows the end-effector 520 in a retracted position with the bellows unit 700 contracted between the plates 800 and 900 and the bellows unit 720 contracted between the plates 802 and 902; the bellows unit 710 is thereby expanded between plates 900 and 802.

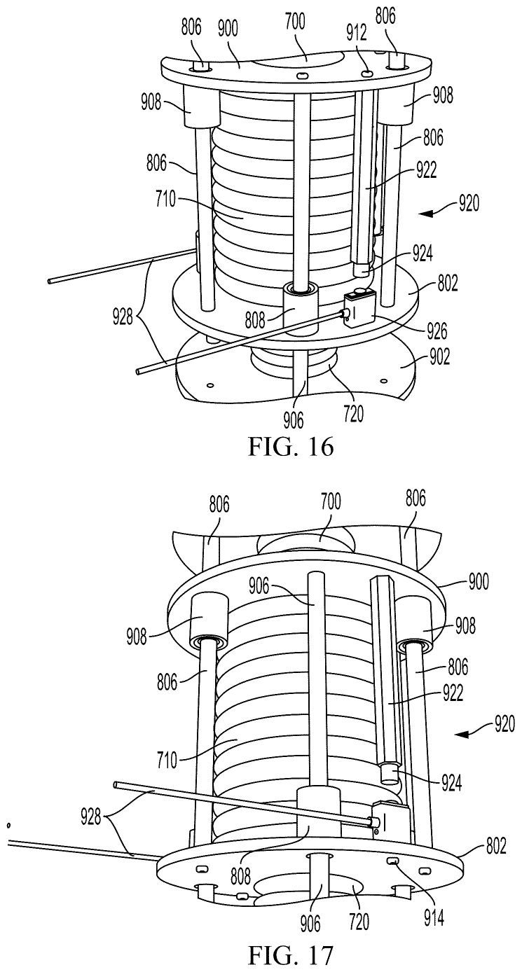

The force detection systems 920 (shown in FIG. 14 but not shown in FIGS. 15A and 15B for clarity) of the end-effector 520 sit between the first portion and the second portion of the end-effector 520. The force detection system may include any number (e.g., one, two, three, four or more) force sensors. For example and with reference to FIG. 16 (which shows the use of two force sensor), the rods 806 freely slide within the bearings 908 and the rods 906 slide freely within the bearings 808. The force detection systems 920 include an actuator portion 922 that is fastened at a proximal side of the plate 900 (e.g., by screw 912) as shown in FIG. 16 and a sensor portion 926 that is fastened at a distal side of the plate 802 (e.g., by a screw 914) as shown in FIG. 17.

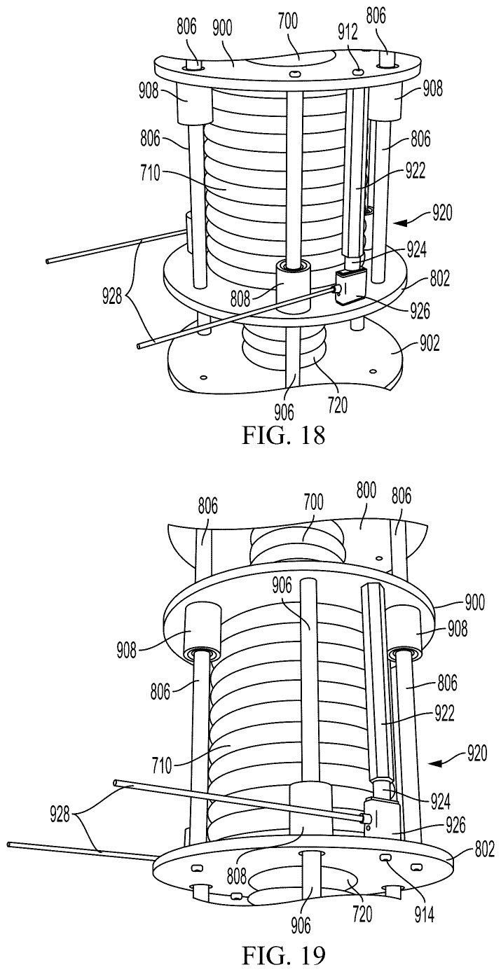

Each actuator portion (e.g., a stand off) of each force detection system 920 is coupled to a bumper 924 such as a rubber bumper, and the stand-off 922 is fastened to the plate 900. The bumper 924 contacts a detection unit 926 as the first portion (the plate 902) of the end-effector moves distally of the second portion (the plate 802) of the end-effector. FIGS. 16 and 17 show a gap between the distal end of the bumper and the proximal side of the detection unit 926 for illustrative purposes. In practice, this gap may be very small, e.g., less than 0.010 inches or less than 0.005 inches such as 0.003 inches. FIG. 18 shows an upper elevational view of the first portion (plate 902) of the end-effector having moved distally of the second portion (plate 802) of the end-effector such that the bumper 924 is in contact with the detection unit 926, and FIG. 19 shows a lower elevation view of the end-effector in the position of FIG. 18. Force detection information is then sent either by an antenna 928 or via hard wiring to the one or more computer processing systems 200.

In accordance with an aspect therefore, the invention provides a force sensing end-effector that includes a first portion (e.g., the plates 900, 902, 904, rods 906, and bearings 908) connected to a vacuum cup that is movable axially with respect to a second portion (e.g., the plates 800, 802, mounting unit 804, rods 806 and bearings 808) that is coupled to a programmable motion device and through which a vacuum is provided in a vacuum chamber that is maintained at a substantially constant volume and pressure irrespective of relative movement of the vacuum shaft 904 with respect to the vacuum chamber assembly 913. The system includes at least one force detection sensor that is positioned to be impacted by movement of the first portion (vacuum shaft 904) with respect to the second portion (the vacuum chamber assembly 913). Note that due to the use of the slide rods passing through the plates 802, 900, the first portion is not able to rotate with respect to the second portion.

In accordance with various aspects of the present invention therefore, the vacuum chamber may be maintained at a substantially constant volume irrespective of movement of a first portion with respect to a second portion. Further, the vacuum chamber may be defined by upper and lower rolling diaphragms or by plates separating in-line pressure-balanced bellows units to accommodate movement of a vacuum shaft relative a vacuum chamber structure such as a housing. In these examples, the vacuum within the chamber is maintained at substantially constant volume and pressure while an object is being held due to the permitted movement of the rolling diaphragms or by the plates separating the in-line-pressure-balanced bellows. A goal of these examples is to isolate (as much as possible) movement of the vacuum hose from interfering with weight measurements, while accommodating movement of a vacuum shaft relative a vacuum assembly.

Additionally, the above force sensing end-effectors of FIGS. 1-19 provide substantial movement of the first portion with respect to the second portion while also providing that the vacuum chamber is maintained at substantially constant volume during such substantial relative movement.

Further approaches to isolating movement of the vacuum hose from weight measurement involve moving the weight measurement further distal of the mounting apparatus that couples the end-effector to the programmable motion device, particularly where the measurement is done when the vacuum cup is furthest from the vacuum hose coupling due to permitted axial-distal movement. As discussed below with reference to FIGS. 20-40, this may be achieved by positioning force-sensing devices outside of a vacuum channel in a system that permits axial movement of the vacuum shaft.

In particular, in accordance with further aspects, the invention provides yet another force sensing end-effector that includes the use of further configurations of force sensors to provide weight sensing as well as torque sensing. In particular, with reference to FIG. 20, and similar to the systems of FIGS. 1 and 11, the object processing system 950 includes an object processing station 935 with a programmable motion device 945 that grasps and moves objects with a force sensing end effector that provides weight (force) sensing to provide an accurate and reliable assessment of the mass of the grasped object despite external influences, and may additionally provide torque sensing. The operation of the programmable motion device 945 at object processing station 935 is controlled by controller 940 in cooperation with the system controller 200 of the object processing system 950. The weight (and torque) sensing end-effector 960 uses vacuum to grasp objects with the vacuum supplied by a high flow vacuum source 930. Again, the high flow vacuum source 930 may, for example, provide an air flow of at least about 100 cubic feet per minute, and a vacuum pressure of no more than about 100,000 Pascals below atmospheric, or no more than about 85,000 Pascals below atmospheric, or no more than about 65,000 or 50,000 Pascals below atmospheric.

Similar to the system 100 of FIG. 1 and the system 500 of FIG. 11, objects to be processed are provided to the programmable motion device 960 at the object processing station 935 in inventory bins 240 to be placed in completed containers 230. Inventory bins 240 are brought into the object processing station 935 from storage or previous processing on inventory input conveyor 160 and inventory input conveyor 170. Once objects are picked from the respective inventory bin 240, the inventory bins 240 are returned to storage or further processing on inventory output conveyor 150 or inventory output conveyor 190. Completed order boxes 230 leave the object processing station 935 on output conveyor 180. Empty order boxes 250 are supplied to the object processing station 935 on input conveyor 220. As such, the illustrative operation of the programmable motion device 945 with the force (weight) and torque sensing end-effector 960 is demonstrated as picking an object from an inventory bin 240 and placing the object in an empty order box 250 to create a completed order box 230. Throughput of the object processing system 950 can be expressed as a number of items picked per unit time, such as picks/hour. Mis-picks, inadvertent multiple picks, and incorrect picks result in any of downtime, rework, or customer returns.

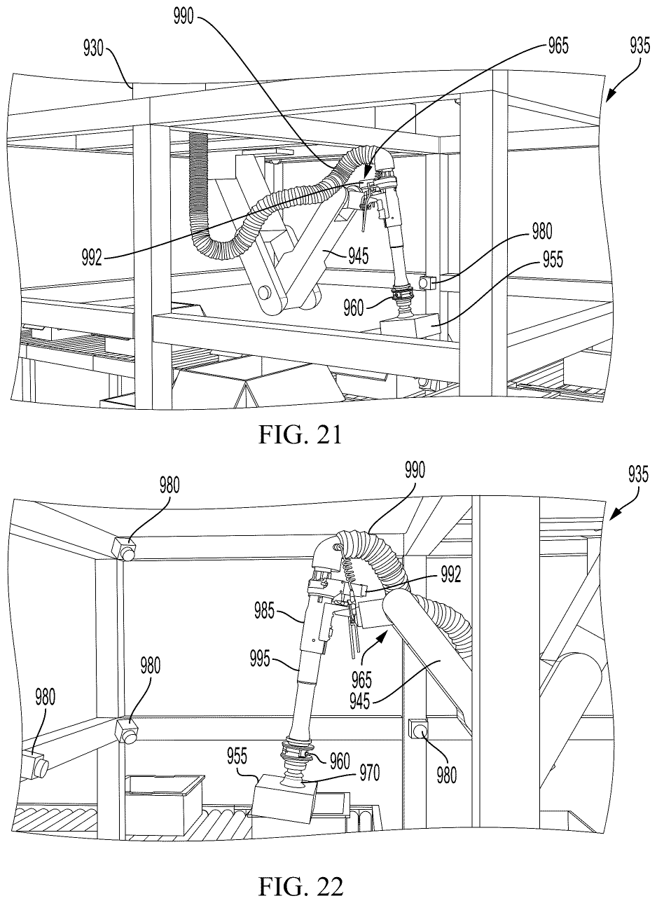

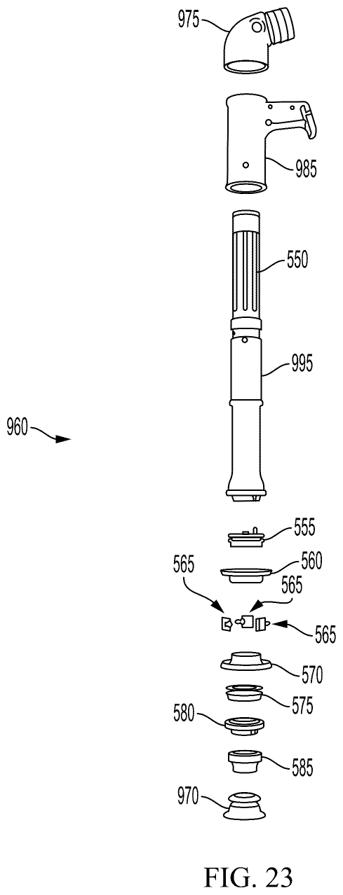

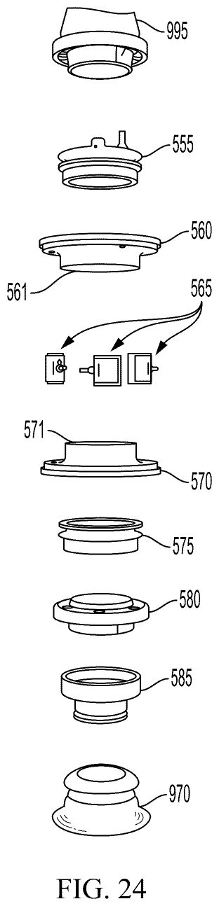

With reference to FIG. 21, the force and torque sensing end-effector 960 is shown at object processing system 935, attached to programmable motion device 945 at the end-effector joint 965. Similarly, the object processing system 935 includes perception systems 980 that provide guidance to the programmable motion device 945, visual verification, and object identification. As shown in FIG. 21, the high flow vacuum source 930 provides vacuum to the force and torque sensing end-effector 960 through vacuum hose 990 and yawing adjustment through rotation of the force sensing end-effector 960 by motor 992. The programmable motion device 945 is shown in a lifted position in that force sensing end-effector 960 is grasping to move an object 955. In this lifted position, it is clear that the vacuum hose 990 will induce tension on the programmable motion device 945 if it were conventionally attached. As will be described below in further detail with reference with FIGS. 23 and 24, the force sensing end-effector 960 isolates the weight and torque sensing function from any deflections applied to the programmable motion device 945, whether from movement of the programmable motion device 945 or dynamic forces induced by the vacuum hose 990 as the grasp becomes effective causing the vacuum pressure to change and vacuum flow to drop.

FIG. 22 shows a rear view of the programmable motion device 945 showing the mounting apparatus 985 that couples the vacuum hose 990 to the end-effector 960 and the programmable motion device 945. As described in more detail below with reference to FIGS. 23 and 24, the end-effector 960 includes a vacuum tube 995 that is coupled to the vacuum hose 990 where the vacuum tube 995 is slidably engaged in the mounting apparatus, and coupled to a vacuum cup 970 (shown grasping an object 955). The vacuum tube 995 is movable with respect to the mounting apparatus 985 to provide a slidable engagement when the vacuum cup 970 makes contact with an object, such as object 955 and rotates the vacuum tube 995 and end-effector 960 in a yawing motion by actuation of the motor 992. As shown at FIG. 22, the vacuum tube 995 fully extends from the mounting apparatus 985 when the grasp is made and the programmable motion device 945 extracts the object 955 from its pick location, thereby permitting the end-effector 960 to perform a weight and torque detection and assessment

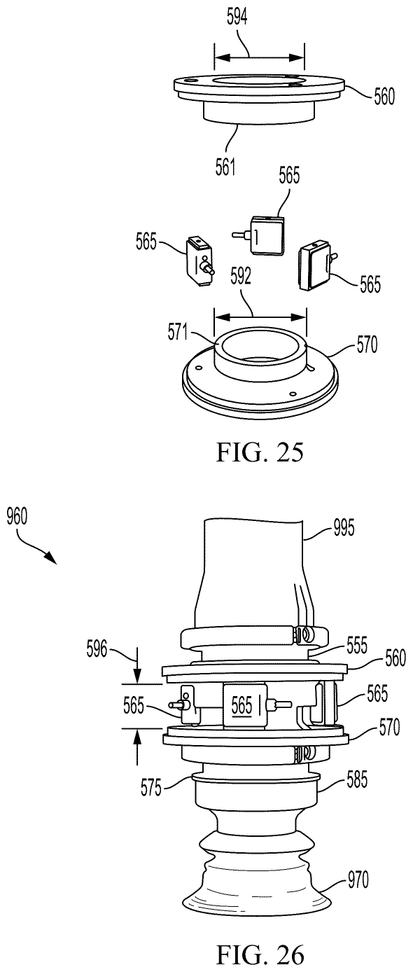

As the articulated arm of the programmable motion device 945 is extended, the vacuum hose 990 will also be extended, which will impact the dynamic forces applied to the programmable motion device 945, particularly at the end-effector joint 965, where typical force measurements are made to establish the weight of the picked item and torque applied to the programmable motion device 945. As will be described in further detail below with reference to FIGS. 25 and 26, the weight and torque sensing end-effector 960 isolates the weight and torque sensing functions of the end-effector from the programmable motion device 945 and the ancillary equipment to provide an accurate and reliable assessment of the weight of the object grasped.

FIG. 23 shows an exploded view of the components of the weight and torque sensing end-effector 960. As noted above with reference to FIG. 22, the vacuum tube 995 is slidably engaged in the mounting apparatus 985 and rotatably coupled to the vacuum hose 990 (not shown) through vacuum fitting 975. Optionally, mounting apparatus 985 can provide a yawing adjustment of the vacuum tube through the use of a motorized gear that slideably engages splines 550 in the vacuum tube 995 so that the vacuum tube is free to retract from the mounting apparatus 985 when the programmable motion device 945 continues a downward motion once contact is made by the vacuum cup 970 on an object, yet once grasped, the vacuum tube 995 and by extension, any object attached to the vacuum cup, can be rotated about the longitudinal axis of the vacuum tube 995.

The exploded view of the weight and torque sensing end-effector 960 of FIG. 23, and the detailed exploded view of the weight and torque sensing end-effector 960 of FIG. 24 includes force sensors (e.g., force torque sensors) 565 that collectively measure the weight of the object grasped on the vacuum cup 970 as well as any torque applied to the programmable motion device 945. The force sensors 565 (e.g., two, three, four or more load cells or force torque sensors) are strategically placed between an upper flange 560 and a lower flange 570 to collectively capture weight measurements. Where force torque sensors are used, torque may also be captured. In an exemplary aspect, the upper flange 560 is attached to the distal end of the vacuum tube 995 with a mounting ring 555 provided therebetween for exchanging the end-effector at an end-effector exchange station. The lower surface 561 of the upper flange 560 may be separated from the upper surface 571 of the lower flange 570 when the force sensors 565 are mounted between the surfaces 561, 571. The gap between the surfaces 561, 571 may be, for example, no more than 0.010 inches, such as 0.005 inches or 0.003 inches. The lower flange 570 is attached to a lower adapter 580 with a second vacuum seal 575 provided therebetween. An adapter 585 couples the vacuum cup 970 to the lower adapter 580. In this first exemplary aspect, the force sensors 565 operate in tension, providing an electrical signal that is proportional to the weight of the object attached to the vacuum cup.

In an alternative exemplary aspect, the upper flange 560 is attached to the lower adapter 580 and the lower flange 570 is attached to the distal end of the vacuum tube 995, thereby placing the force sensors 565 in compression when a load is applied when an object is grasped at the vacuum cup 970. In either aspect, the torque applied to the programmable motion device 945 by the load, and in particular, the torque applied between the upper and lower flanges 560, 570 is detected by the force sensors 565.

Each of the elements of the force sensing end-effector 960 includes a central bore through which high flow vacuum, supplied by the high flow vacuum source 930 via the vacuum hose 990 is routed to the vacuum cup 970. In this way, when activated, the high flow vacuum source provides high flow vacuum to the vacuum cup 970 to provide a grasping force on an object even if a perfect vacuum seal is not established at the vacuum cup 970.

FIG. 25 provides a detailed view of the components of the end-effector 960 that provide weight and torque detection and assessment. As described above with reference to FIGS. 23 and 24, the force sensors 565 (whether arranged for measurement in tension or compression) provide a signal collectively proportional to the weight of the object grasped by the vacuum cup 970. When multiple force sensors 565 (e.g., two, three, four etc.) are arranged between the upper flange 560 and the lower flange 570, the collective signals of the multiple force sensors 565 can provide differential readings that can determine the torque applied to the end-effector 960 by virtue of an unbalanced load, such as if the grasped object is not grasped at its center of mass. Furthermore, the differential signals from the respective force sensors 565 can accordingly be used to locate the center of mass of a grasped object. While the exemplary aspects of the present invention are provided in the figures of the drawings with three force sensors 565, one skilled in the art will appreciate that one, two, or any of a plurality of force sensors can be provided between the upper flange 560 and the lower flange 570 to provide the same, or possibly more accurate detection and assessment of the weight of a grasped object.

FIG. 25 depicts the relative position of the upper flange 560 to the lower flange 570 in an exploded view. The inner bore 594 of the upper flange and the outer bore 592 of the lower flange 570 are provided for a precision slip fit so that resistance from the interface between the upper flange 560 and the lower flange 570 does not impact the forces applied to the force sensors 565. The precision machined gap between the bore 594 of the upper flange and the bore 592 of the lower flange must not be so great as to significantly leak ambient air into the high flow vacuum stream supplied by the vacuum source 930, thereby reducing the grasping force of the object on the vacuum cup 970. A sealed interface, such as through the fitting of an O-ring between bore 594 and bore 596 has not been found to be advantageous, as a slight vacuum leak provides an air cushion that effectively eliminates any frictional component of resistance to forces applied on the force sensors 565 from the grasped object.

FIG. 26 provides a detailed view of the weight and torque sensing end-effector 960. The vertical gap 596 between the upper flange 560 and the lower flange 570 is sized so that the vertical gap 596 is not less than the safe operational range of the force sensors 565. In this way, if the programmable motion device 945 is operated, whether intentionally or unintentionally, to crash into any object or objects to be grasped, the forces applied on the force sensors 565 can be managed to fall at or below the operational range of the device.

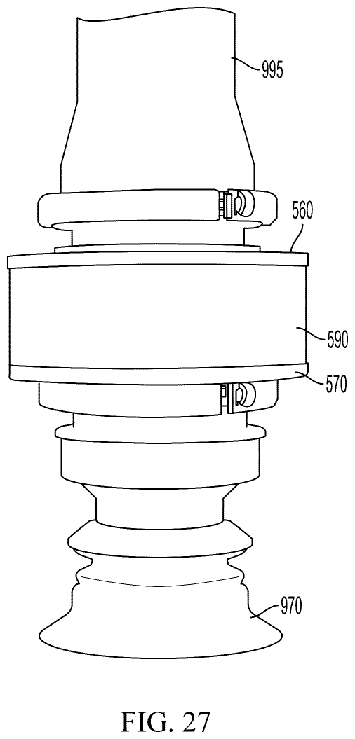

FIG. 27 depicts the force sensing end-effector 960 with a protective shroud 590 that protects the force sensors 565 from the operational environment. Communication with the force sensors 565 may be either wireless or via wiring through one or more openings in the protective shroud 590.

In accordance with further aspects, force sensing end-effectors of the invention (including those discussed above with reference to FIGS. 1-26) may therefore be used with high flow vacuum systems even as they cycle the vacuum supply on and off, and vary both vacuum pressure to change and vacuum flow during use, for example as objects are grasped and released by the end-effector. Further, adverse forces on the force detection system such as from the movement in reaction to cycling of the high flow vacuum hoses are also minimized or avoided all together.

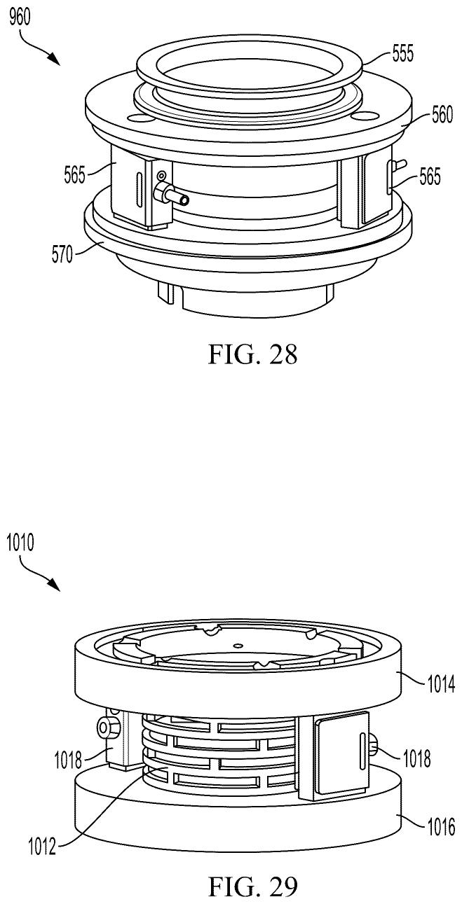

FIG. 28 shows the force-sensing end-effector 960 as assembled with the upper flange 560 and the lower flange 570 capturing the force sensors 565 therebetween, with a small gap (e.g., 0.010 inches or 0.005 inches or 0.004 inches or 0.003 inches or 0.002 inches between the flanges 560, 570). The mounting ring 555 is attached (e.g., via threads) to the upper flange 560. The end-effector 960 may be retrofitted onto a standard vacuum gripper. The load cells only deflect roughly 0.003 inches. A compliant housing may therefore be provided that may be used to transfer load onto the load cells. This results in a compact package that is small enough to attach to the end of a gripper. The design separates the airflow and the load cells by placing the load cells outside of the tube.

Any of two, three, four etc. force sensors may be used. The use of three or more load cells provides the ability to more accurately measure torque and determine the center of gravity of the grasped object, which enables pick failure detection and permits compensation dynamics in trajectory optimization. In this way, the effects of grasping an object that exhibits a suspension of a significant portion of the mass (e.g., swinging or pendulum effects, or if the package hinges open while grasping the top) or the effects of a grasp changing (e.g., when a second object is on the grasped object but slides off (the pizza box effect)) can be compensated for in determining the mass of the grasped object from the data acquired from the load cells. The end-effector can be calibrated using data generated from an automated test rig as discussed in more detail below with reference to FIGS. 41-43. Settling times from internal hysteresis may vary depending on any of the inherent settling time of the load cells, the settling time of the end-effector hardware, or the time to reach a steady state vacuum pressure. If, for example, it is known that the pressure and the load reach steady-state at near the same time, the pressure could be assumed to be the source of the steady state readings. In this case, applying a calibration (as discussed below with reference to FIGS. 41-43) for a given time step should be possible, allowing the estimation of weight of an object prior to the system reaching steady-state.

FIG. 29 shows a split tube force-sensing end-effector 1010 in accordance with another aspect of the present invention that includes a compliant split-tube 1012 between an upper flange 1014 and a lower flange 1016, with the two, three or four force sensors 1018 positioned therebetween. The end-effector 1010 is not a constant volume end-effector as the compliant split-tube permits movement in six degrees of freedom. Any vacuum pressure will directly impart a force on the force sensors, but this additional force may be calibrated against pressure to remove the extraneous forces as discussed below with reference to FIGS. 41-43. The housing material may also be moderately viscoelastic, and if it has a has high damping coefficient, this may contribute to settling times. If the coefficients may be accurately determined, then it is possible to predict the steady-state mass readings given initial readings from the force sensors.

In accordance with an aspect, the pressure value at each time step was recorded and the mass for a given time step was calibrated. The settling time for both the calibrated and uncalibrated mass was approximately the same, which suggests that the settling time of the load cells is not dependent on reaching a steady-state pressure.

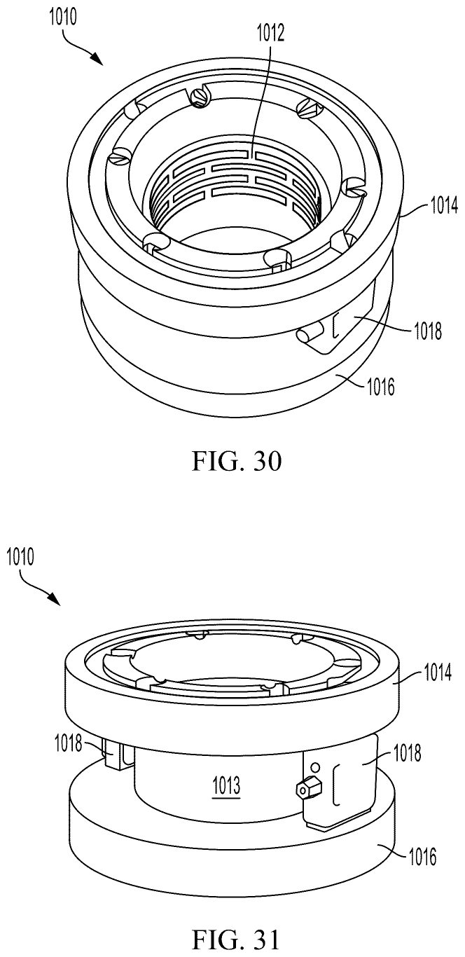

FIG. 30 shows an elevated view of the end-effector 1010 showing the compliant split-tube 1012 from the inside that again is sandwiched between the upper and lower housing flanges 1014, 1016. The split-tube 1012 may be covered by a very flexible thin cover 1013 as shown in FIG. 31 that is positioned between the split-tube 1012 and the (two) forcer sensors 1018.

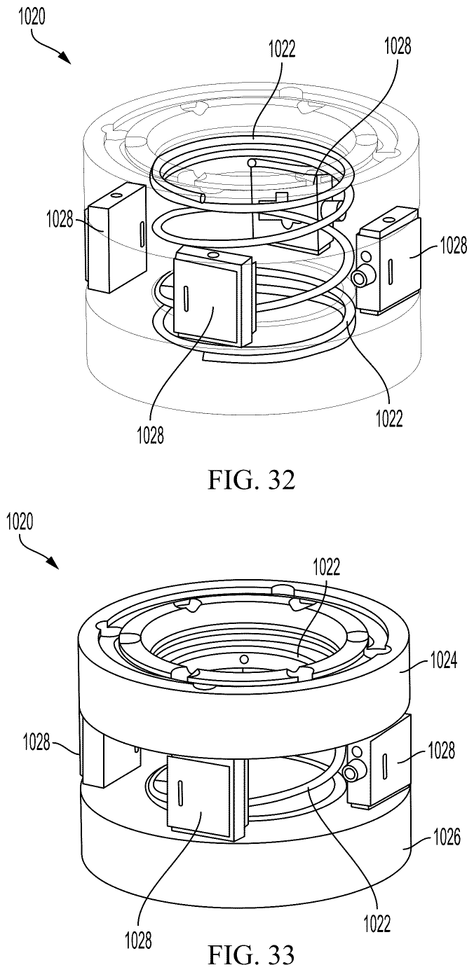

In accordance with another aspect, an end-effector 1020 may be provided that includes an elastic material (e.g., a spring 1022) between the upper flange 1024 and the lower flange 1026 as shown in FIGS. 32 and 33. The elastic material (e.g., metal) may reduce any drift. The spring may also be wrapped in a thin membrane (e.g., Nylon tape, gaffer's tape, or Lock Port gaffer's tape, etc.). FIG. 32 shows the end-effector 1030 without the housing flanges and FIG. 33 shows the end-effector 1030 with the upper and lower housing flanges 1024, 1026.

A spring, for example, may be selected that has a near negligible spring force while retaining a high coil count and highwire diameter to minimize collapse of the air-tight membrane around the spring. Because the spring rate of the spring is much smaller than the spring rate of single load cell, it may be assumed that the force of the spring does not meaningfully change the impact of the force measurements of the load cells; compensation may therefore not be required.

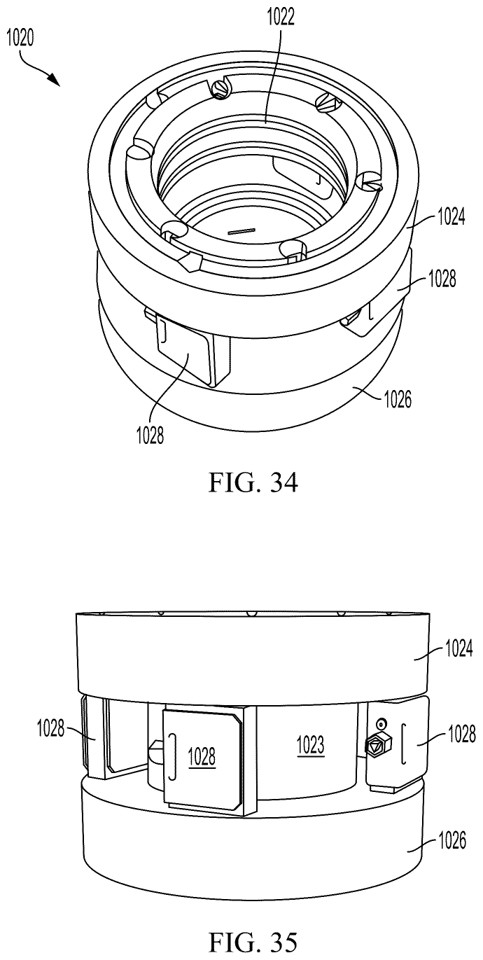

FIG. 34 shows an elevated view of the end-effector 1020 showing the elastic spring material 1022 that again, is sandwiched between the upper and lower housing flanges 1024, 1026. The elastic material 1022 may be covered by a very flexible thin cover 1023 as shown in FIG. 35 that is positioned between the split-tube 1022 and the (four) force sensor 1028.

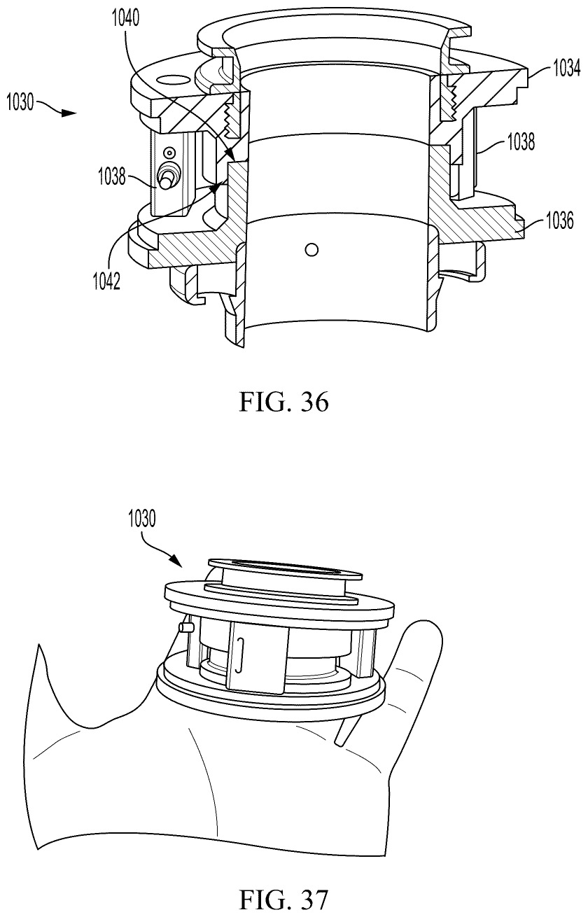

In accordance with a further aspect, an end-effector 1030 may include multidirectional gap as shown in FIG. 36. The multi-directional gap between the upper flange 1034 and the lower flange 1036 may include a step interface that provides a horizontal contact area shown at 1040 as well as an annular vertical contact area shown at 1042. The use of the multi-directional gap may reduce pressure loss. Two force sensors 1038 are shown that are attached to the upper flange 1034 and the lower flange 1036 to operate in tension. A third (or more) force sensors 1038 will also increase the overall capacity of the attachment. An alternative configuration where the lower flange 1036 can be sleeved in the upper flange 1034 to configure the force sensors 1038 in compression.

FIG. 37 shows the assembled device. Where three force sensors are used, for example, the center of gravity may be determined as follows:
Where rᵢ=(xᵢ, yᵢ) represents the location of the load cells with respect to center of the tube. r_{cg}=(x_{cg}, y_{cg}) represents the location of the CG of the object being weighed.

$${\sum }_{i = 1}^{3} {F}_{i} ( {r}_{i} - {r}_{cg} ) = 0$$

$${F}_{1} ( {r}_{1} - {r}_{cg} ) + {F}_{2} ( {r}_{2} - {r}_{cg} ) + {F}_{3} ( {r}_{3} - {r}_{cg} ) = 0$$

### Rearrange for r_{cg}

$${r}_{cg} = \frac{( {F}_{1} {r}_{1} + {F}_{2} {r}_{2} + {F}_{3} {r}_{3} )}{{F}_{1} + {F}_{2} + {F}_{3}}$$

$${x}_{cg} = \frac{( {F}_{1} {x}_{1} + {F}_{2} {x}_{2} + {F}_{3} {x}_{3} )}{{F}_{1} + {F}_{2} + {F}_{3}}$$

$${y}_{cg} = \frac{( {F}_{1} {y}_{1} + {F}_{2} {y}_{2} + {F}_{3} {y}_{3} )}{{F}_{1} + {F}_{2} + {F}_{3}}$$

The end-effector 1030 of FIGS. 36 and 37 incorporates the hard stops of prior disclosed designs and reduces the pressure losses. Initial testing showed a pressure loss of 0.07 psi and a total error of approximately 120 g across five picks, indicating good repeatability. The multidirectional gap may be, for example, 0.004″ to 0.012″, with no effect on pressure loss.

Across all designs, turbulence may contribute to load cell variability; the blade of the throttle body on the pressure calibration rig may induce turbulence. A flow straightener may be designed to be installed downstream of the blade to potentially reduce this variation.

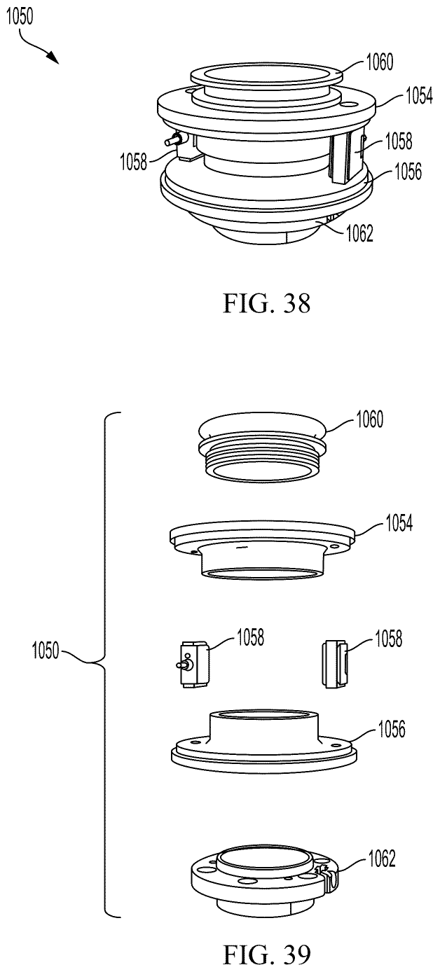

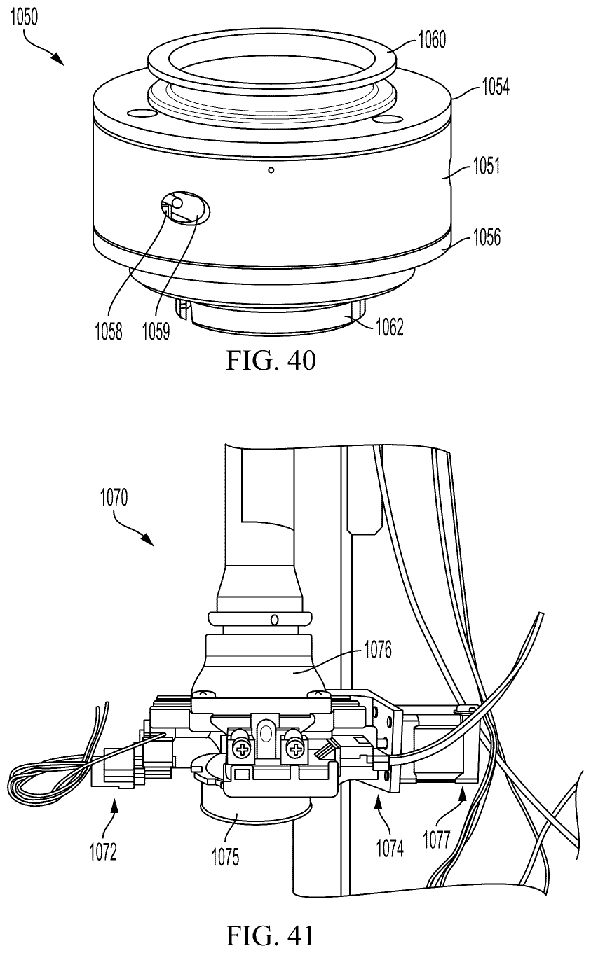

FIG. 38 shows the force-sensing end-effector 1050 as assembled with the upper flange 1054 and the lower flange 1056 capturing two force sensors 1058 positioned therebetween and positioned 180 degrees apart, in a split tube configuration with a small gap (e.g., 0.010 inches or 0.005 inches or 0.004 inches or 0.003 inches or 0.002 inches between the flanges 1054, 1056). The mounting ring 1060 is attached (e.g., threaded, press-fit or welded) to the upper flange 1054. The end-effector 1050 may be retrofitted onto a standard vacuum gripper. Either of the two force sensors 1058 only deflect a small amount, e.g., 0.003 inches. This results in a compact package that is small enough to attach to the end of a gripper. The design separates the airflow and the load cells by placing the force sensors outside of the tube. FIG. 39 shows an exploded view of the split tube force sensing end-effector 1050, with the two force sensors 1058 positioned therebetween. The end-effector 1050 is effectively a constant volume end-effector as the compliant split-tube permits very little movement in six degrees of freedom. Any vacuum pressure will directly impart a force on the force sensors, but this additional force may be calibrated against pressure to remove the extraneous forces as discussed below with reference to FIGS. 41-43. If the coefficients may be accurately determined, then it is possible to predict the steady-state mass readings given initial readings from the load cells.

The force sensing end effectors described herein, including, for example, force sensing end effector 1050 of FIG. 38, effectively grasps an object when the object forms a seal in the vacuum opening when the high flow vacuum supply is providing vacuum. Once grasped, the vacuum supply evacuating the central opening of the force sensing end effector 1050 creates a vacuum force that closes the gap between the upper flange 1054 and the lower flange 1056 that can be measured by the force sensors 1058 which is proportional to the absolute pressure in the chamber, which is a function of the vacuum pressure from the vacuum supply and any leakage from imperfect sealing within the overall system. The vacuum force is offset by the mass of the object, which can be impacted by gravitational forces and dynamic forces applied by motion of the programmable motion device moving the grasped object. The pressure in the chamber also fluctuates depending on several factors, including the seal at the point of grasp by virtue of the suction cup at the distal end of the end effector.

These pressure changes cause corresponding load variations on the respective load cells 1058 that are due to a combination of fluid dynamics effects. One potential source of fluid dynamic effects include an imperfect seal around the periphery of the vacuum cup grasp of the object, which generates uneven and unbalanced pressure in the area on the top and bottom of the split tube, which creates a buoyant force on the lower flange 1056 thereby pushing the flange into the force sensors 1058. Another potential source of fluid dynamic effects includes the momentum change as fluid (air) is redirected inside the chamber, which then transfers force into the bottom flange, thereby reducing the net reading on the force sensors.

These forces can be quantified through complex and time-consuming modeling of the principles of fluid-force dynamics, or fit an empirical model to experimental data. In order to achieve a practical, yet precise, understanding of the forces that result from the variations due to vacuum leakage at the point of grasp, the latter approach using a data driven approach was selected.

The end-effector 1050 may further include a very flexible thin housing cover 1051 around the outside of the force sensors 1058 and between the upper and lower housing flanges 1054, 1056 as shown in FIG. 40. The covers 1013 and 1023 may end just below each of the respective housing flanges so as to not inhibit weight measurements. The covers 1013, 1023, 1051 may facilitate keeping any debris from adversely impacting the sensitivity of the force-sensing systems discussed above with reference to FIGS. 31, 35 and 40, and may, for example, be formed of a clear polymeric material or an elastomeric material. The force sensing end-effectors of FIGS. 20-40 provide movement of the first portion with respect to the second portion while also providing that the vacuum chamber is maintained at substantially constant volume during such relative movement.

FIG. 41 depicts a test apparatus 1070 that includes a force sensing end effector 1076 of the split tube variety with at least two force sensors including first force sensor 1072 and second force sensor 1074. The test apparatus 1070 includes a throttle body 1075 driven by a stepper motor 1077 that can sweep the throttle body valve angle in 1.5 degree increments from no airflow to full airflow, while recording both pressure in the chamber of the end effector and the readings of force sensor 1072 and force sensor 1074. The fluid force is calculated by subtracting the baseline load cells reading from each measurement.

A quadratic curve 1080

$$F = {aP}^{2} + bP + c$$

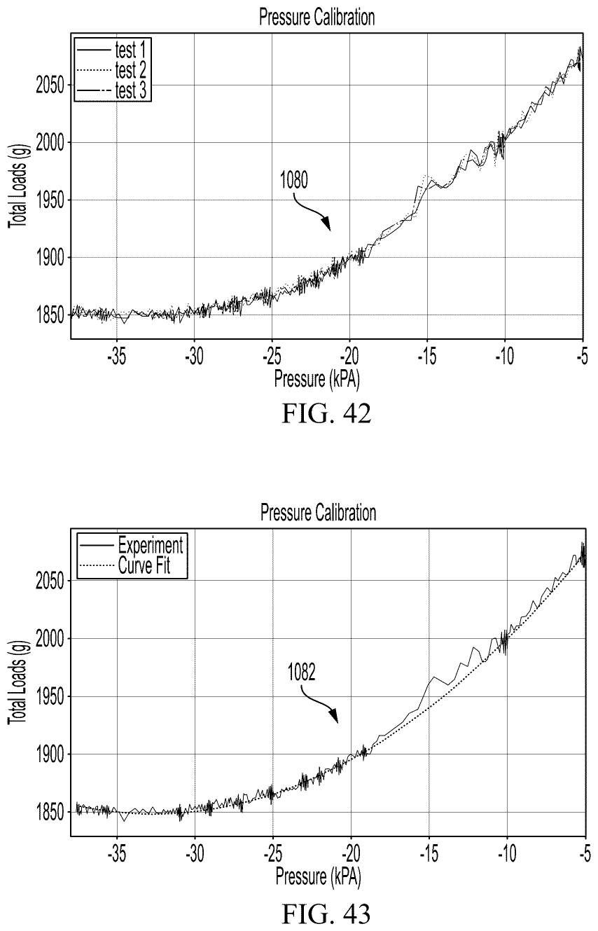

is fit to the collected data (where P is pressure, F is fluid force and a, b, and c are the fitted parameters), as shown in FIG. 42. Other methods, such as interpolation, may alternatively be applied. The fluid force offset is applied to the raw force sensor values to extract the true object mass. As shown in FIG. 42, the results of three independent trials, plotting total load on the two load cells against measured pressure in the chamber.

FIG. 43 represents an assessment of the curve-fitting exercise showing the variance 1082 from the experimental data to the quadratic curve. The variance 1082 is minimal indicating the measured forces are closely fit to a quadradic curve demonstrating the measured results can be accurately predicted by the evaluated relationship. With the quadradic equation established for the relationship between pressure and force as measured from the force sensors of the end-effector of the present invention, the mass of an object at the moment it is grasped can be instantly derived.

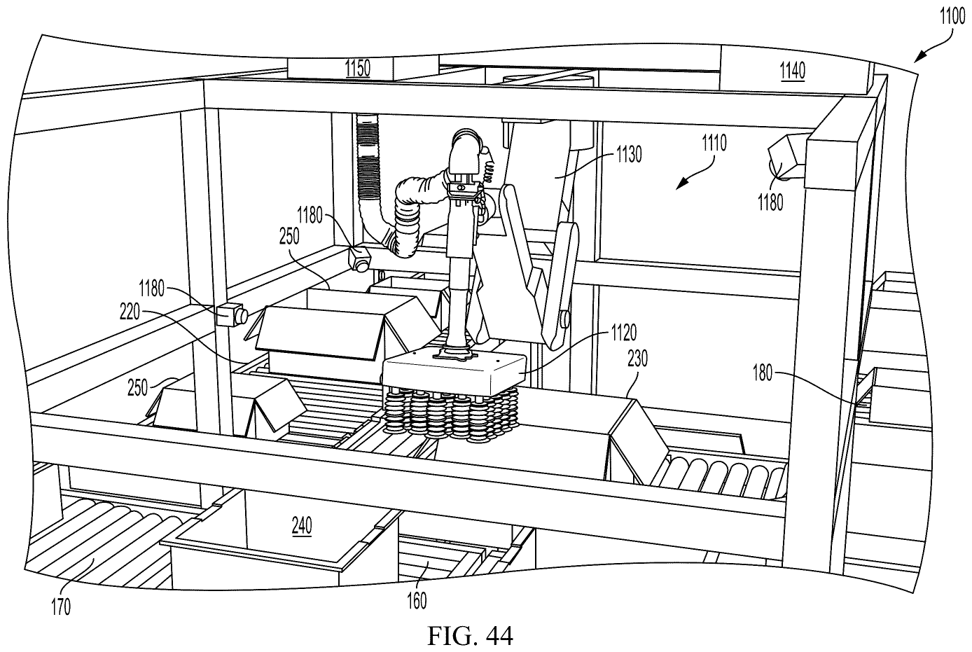

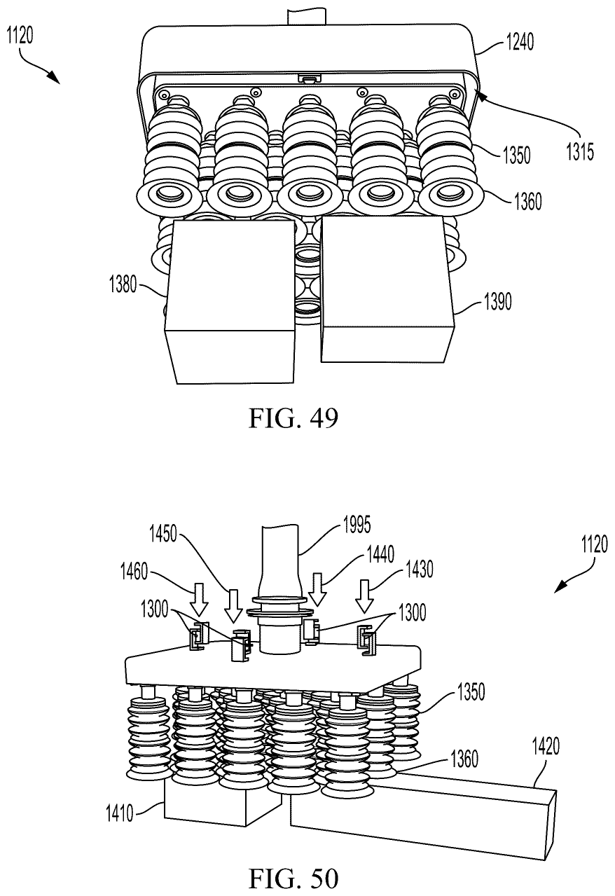

Further approaches to isolating movement of the vacuum hose from weight measurement involve moving the weight measurement further distal of the mounting apparatus that couples the end-effector to the programmable motion device, particularly where the measurement is performed using an array of vacuum cups. As discussed below with reference to FIGS. 44 and 49, this may be achieved by positioning force-sensing devices about an extended area to increase the resolution of data available for analysis when an object, or multiple objects, are grasped.

In particular, in accordance with further aspects, the invention provides yet another force sensing end-effector that includes the use of a certain configuration of an array of vacuum cups with force sensors (e.g., load sensors or force torque sensors). In particular, with reference to FIG. 44, and similar to the systems of FIGS. 1, 11, and 20, an object processing system 1100 includes an object processing station 1110 with a programmable motion device 1130 that grasps and moves objects with a force sensing array end-effector 1120 that provides an accurate and reliable assessment of the mass of any one or more grasped objects despite external influences. The operation of the programmable motion device 1130 at object processing station 1110 is controlled by controller 1140 in cooperation with the system controller 200 of the object processing system 1100. The force sensing array end-effector 1120 uses an array of vacuum cups to grasp objects with the vacuum supplied by a high flow vacuum source 1150. Again, the high flow vacuum source 1150 may, for example, provide an air flow of at least about 100 cubic feet per minute, and a vacuum pressure of no more than about 100,000 Pascals below atmospheric, or no more than about 85,000 Pascals below atmospheric, or no more than about 65,000 or 50,000 Pascals below atmospheric.

Similar to the system 100 of FIG. 1, the system 500 of FIG. 11, and the system 950 of FIG. 20, objects to be processed are provided to the programmable motion device 1130 at the object processing station 1110 in inventory bins 240 to be placed in completed containers 230. Inventory bins 240 are brought into the object processing station 1110 from storage or previous processing on inventory input conveyor 160 and inventory input conveyor 170. Once objects are picked from the respective inventory bin 240, the inventory bins 240 are returned to storage or further processing on inventory output conveyor 150 or inventory output conveyor 190. Completed order boxes 230 leave the object processing station 1110 on output conveyor 180. Empty order boxes 250 are supplied to the object processing station 1110 on input conveyor 220. As such, the illustrative operation of the programmable motion device 1130 with the force sensing array end-effector 1120 is demonstrated as picking an object from an inventory bin 240 and placing the object in an empty order box 250 to create a completed order box 230. Throughput of the object processing system 1100 can be expressed as a number of items picked per unit time, such as picks/hour. Mis-picks, inadvertent multiple picks, and incorrect picks result in any of downtime, rework, or customer returns.

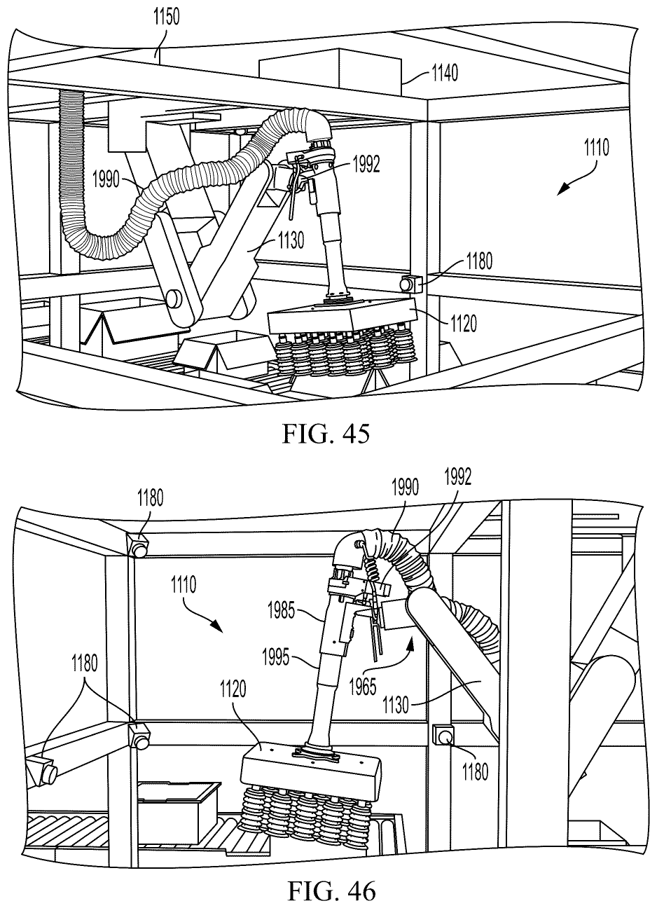

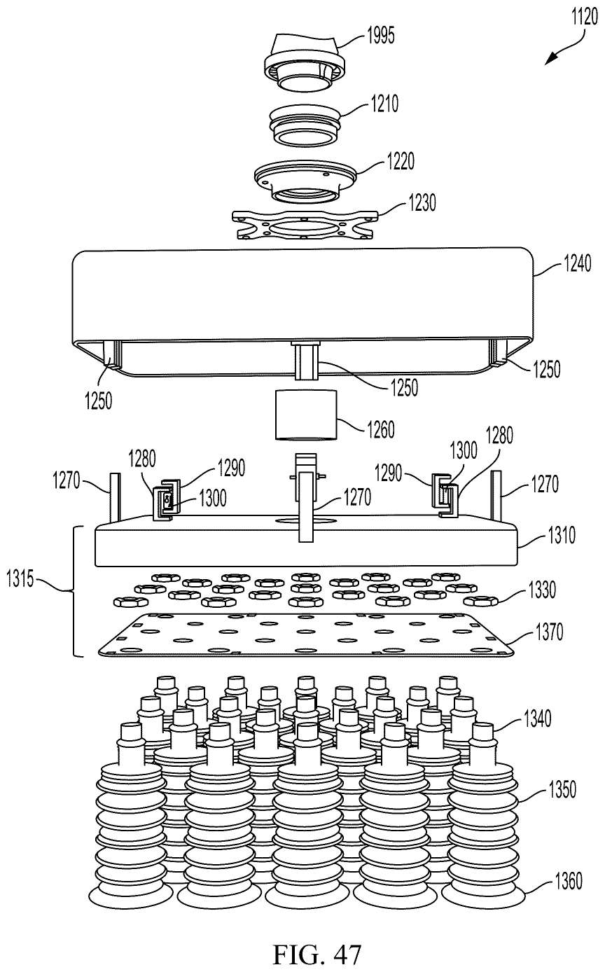

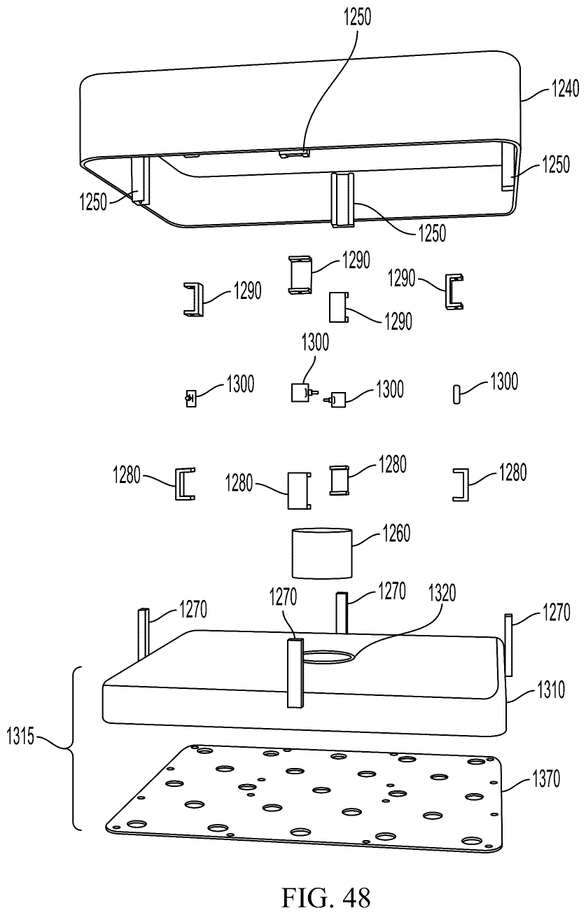

With reference to FIG. 45 the force sensing array end-effector 1120 is shown at the object processing station 1110. Similarly, the object processing station 1110 includes perception systems 1180 that provide guidance to the programmable motion device 1130, visual verification, and object identification. As shown in FIG. 46, the high flow vacuum source 1150 provides vacuum to the force sensing array end-effector 1120 through the vacuum hose 1990 and yawing adjustment through rotation of the force sensing array end-effector 1120 by motor 1992. The programmable motion device 1130 is shown in a lifted position in that the force sensing array end-effector 1120 is moving to grasp an object. In this lifted position, it is clear that the vacuum hose 1990 will induce tension on the programmable motion device 1130 if it were conventionally attached directly to the force sensing array end-effector 1120. As will be described below in further detail with reference with FIGS. 47 and 48, the force sensing array end-effector 1120 isolates the weight and sensing function from any deflections applied to the programmable motion device 1130, whether from movement of the programmable motion device 1130 or dynamic forces induced by the vacuum hose 1990 as the grasp becomes effective causing the vacuum pressure to change and vacuum flow to drop.

FIG. 46 shows a rear view of the programmable motion device 1130 showing the mounting apparatus 1985 that couples the vacuum hose 1990 to the force sensing array end-effector 1120 and the programmable motion device 1130. As described in more detail below with reference to FIGS. 47 and 48, the force sensing array end-effector 1120 is cooperatively mounted to a vacuum tube 1995 that is coupled to the vacuum hose 1990 where the vacuum tube 1995 is slidably engaged in the mounting apparatus 1985, and coupled to the force sensing array end-effector 1120. The vacuum tube 1995 is movable with respect to the mounting apparatus 1985 to provide a slidable engagement when the force sensing array end-effector 1120 makes contact with an object, and rotates the vacuum tube 1995 and the force sensing array end-effector 1120 in a yawing motion by actuation of the motor 1992. As shown at FIG. 46, the vacuum tube 1995 fully extends from the mounting apparatus 1985 when the grasp is made and the programmable motion device 1130 extracts the grasped object from its pick location, thereby permitting the force sensing array end-effector 1120 to perform a weight and torque detection and assessment.

As the articulated arm of the programmable motion device 1130 is extended, the vacuum hose 1990 will also be extended, which will impact the dynamic forces applied to the programmable motion device 1130, particularly at the end-effector joint 1965, where typical force measurements are made to establish the weight of the picked item and torque applied to the programmable motion device 1130. As will be described in further detail below with reference to FIGS. 47 and 48, the force sensing array end-effector 1120 isolates the weight and torque sensing functions of the end-effector from the programmable motion device 1130 and the ancillary equipment to provide an accurate and reliable assessment of the weight of the object grasped.

FIG. 47 shows an exploded view of the force sensing array end-effector 1120 to show the internal mechanism that provides weight sensing with an array of vacuum cups 1360. The vacuum tube 1995, as described with reference to FIG. 46, is rigidly attached to the outer body 1240 by a mounting coupling 1220 and a mounting plate 1230 so that the outer body 1240 does not rotate relative to the vacuum tube 1995. As noted with reference to FIG. 46, a yawing motion of the force sensing array end-effector 1120 is induced by rotation of the vacuum tube 1995. A vacuum coupling 1210 provides a vacuum seal to the environment at the mounting position of the vacuum tube 1995 to the outer body 1240, that is slidably engaged with a conduit tube 1260 in opening 1320 to direct high flow vacuum from the vacuum tube 1995 to the vacuum chamber 1315 created by the attachment of the bottom plate 1370 to the vacuum chamber cover 1310.

With continued reference to FIG. 47, an array of suction cups 1360, each attached to bellows 1350 are fixedly attached to the bottom plate 1370 of the vacuum chamber cover 1310 with attachment nut 1330 that is threadedly engaged to the proximal end of the suction element 1340 where vacuum flow is directed therethrough, each of the array of suction cups 1360 being fluidly coupled to the vacuum chamber 1315.

With continued reference to FIG. 47 and with reference to FIG. 48, the force sensing array end-effector 1120 provides for relative motion between the vacuum chamber 1315 and the outer body 1240 that is attached to the vacuum tube 1995 that is constrained by a precision slip fit between channel guides 1250 inside the outer body 1240 and the guide protrusions 1270 of the vacuum chamber cover 1310. The relative motion permits a distribution of force resulting from the weight of the vacuum chamber 1315 (and any payload attached to the array of vacuum cups 1360) to be applied to force sensors 1300 (e.g., load cells or force torque sensors) disposed between inner cover fixtures 1280 and outer cover fixtures 1290. The outer cover fixtures 1290 are rigidly attached to the bottom side of the outer cover 1240 while the inner cover fixtures 1280 are rigidly attached to the top side of the inner cover 1310 to place the force sensors in compression when the force sensing array end-effector 1120 has an object grasped. Alternatively, inner cover fixtures 1280 and outer cover fixtures 1290 can be in a reverse configuration to place the force sensors 1300 in tension when the force sensing array end-effector has an object grasped. Accordingly, with each force sensor 1300 disposed between the inner cover fixtures 1280 and outer cover fixtures 1290, a force distribution can be measured in response to weight forces applied when an object is grasped by the force sensing array end-effector 1120.

FIG. 49 depicts the force sensing array end-effector 1120 from a lower perspective while simultaneously grasping a first object 1380 and a second object 1390. Because the force sensing array end-effector 1120 is supplied with high flow vacuum from the high flow vacuum source 1150 (as shown in FIG. 44), the array of suction cups 1360 can provide a grasping force on one or more objects when any one of the array of suction cups 1360 is partially covered or completely uncovered by the first object 1380 or the second object 1390 since the high flow vacuum creates negative pressure for a grasping force despite an imperfect vacuum seal at the point of grasp. With both the first object 1380 and the second object 1390 grasped by the force sensing array end-effector 1120, the vacuum chamber 1315 will exert a distribution of force on each of the force sensors 1300 (from FIGS. 47 and 48) commensurate to the mass distribution across the array of suction cups 1360 resulting from the grasp of an object grasped including, for example, the combination of the first object 1380 and the second object 1390.

The force sensing end-effectors of FIGS. 44-50 provide movement of the first portion with respect to the second portion while also providing that the vacuum chamber is maintained at substantially constant volume during such relative movement.

With reference to FIG. 50, which shows the force sensing array end-effector 1120 with the outer cover 1240 removed for clarity, an alternative exemplary group of objects, including third object 1410 and fourth object 1420, are grasped. Here, fourth object 1420 is grasped off-center, to demonstrate the distribution of force applied to the force sensors 1300 by the mass of the grasped objects, shown as arrows 1430, 1440, 1450 and 1460. One skilled in the art will appreciate that if the mass of the fourth object 1420 is greater than the third object 1410, the force applied at arrow 1430 will be greater than at arrow 1460, and the center of mass of the combined objects will therefore be off-center of the force sensing array end-effector 1120. In this way, the multiple object grasping can be detected and analyzed by the output of the individual responses of each of the force sensors 1300. The force detection may be via compression as discussed above, and optionally, if the force sensors are bonded to the inner cover fixtures 1280 and outer cover fixtures 1290, tension at certain force sensors may also be detected.

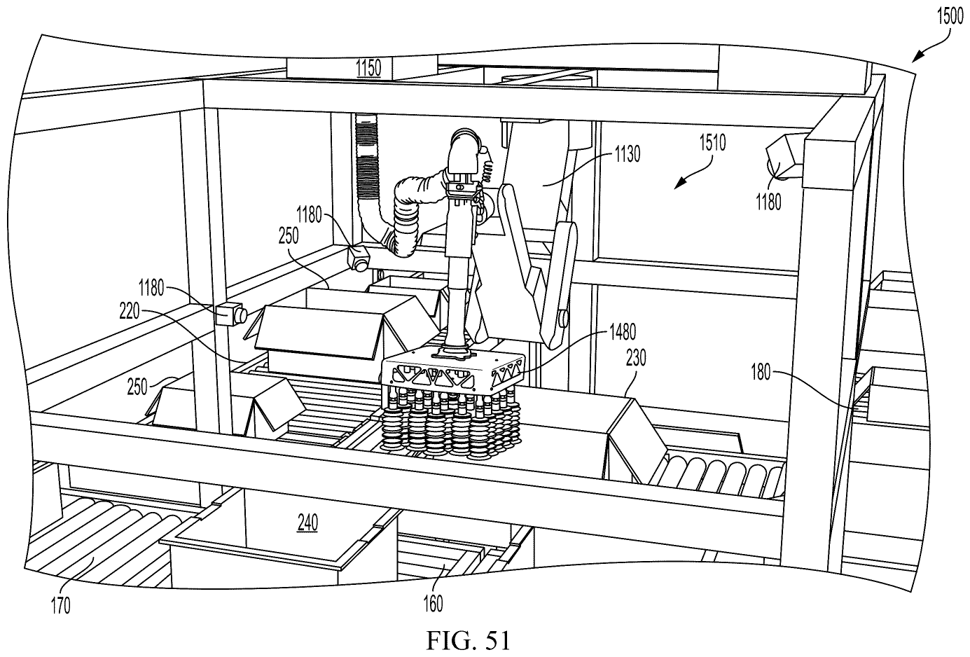

The force sensing array end-effector 1120 of FIGS. 44-50 provides force and weight sensing of an object or objects grasped with a force distribution similar to the force sensing end-effector 120 of FIG. 1, the force sensing end-effector 520 of FIG. 11, and the weight and torque sensing end-effector 960 of FIG. 20 in that the distribution of forces detected are commensurate to the mass and center of gravity of the object (or objects) grasped. To provide an increased resolution of the forces applied by any one or more objects grasped, an aspect of the present invention is shown as an alternative force sensing array end-effector 1480 at FIG. 51.

Similar to the system 100 of FIG. 1, the system 500 of FIG. 11, the system 950 of FIG. 20, and the system 1100 of FIG. 44, object processing system 1500 is shown at FIG. 51. Objects to be processed are provided to the programmable motion device 1130 at the object processing station 1510 in inventory bins 240 to be placed in completed containers 230. Inventory bins 240 are brought into the object processing station 1510 from storage or previous processing on inventory input conveyor 160 and inventory input conveyor 170. Once objects are picked from the respective inventory bin 240, the inventory bins 240 are returned to storage or further processing on inventory output conveyor 150 or inventory output conveyor 190. Completed order boxes 230 leave the object processing station 1510 on output conveyor 180. Empty order boxes 250 are supplied to the object processing station 1510 on input conveyor 220. As such, the illustrative operation of the programmable motion device 1130 with the alternative force sensing array end-effector 1480 is demonstrated as picking an object from an inventory bin 240 and placing the object in an empty order box 250 to create a completed order box 230. Throughput of the object processing system 1500 can be expressed as a number of items picked per unit time, such as picks/hour. Mis-picks, inadvertent multiple picks, and incorrect picks result in any of downtime, rework, or customer returns.

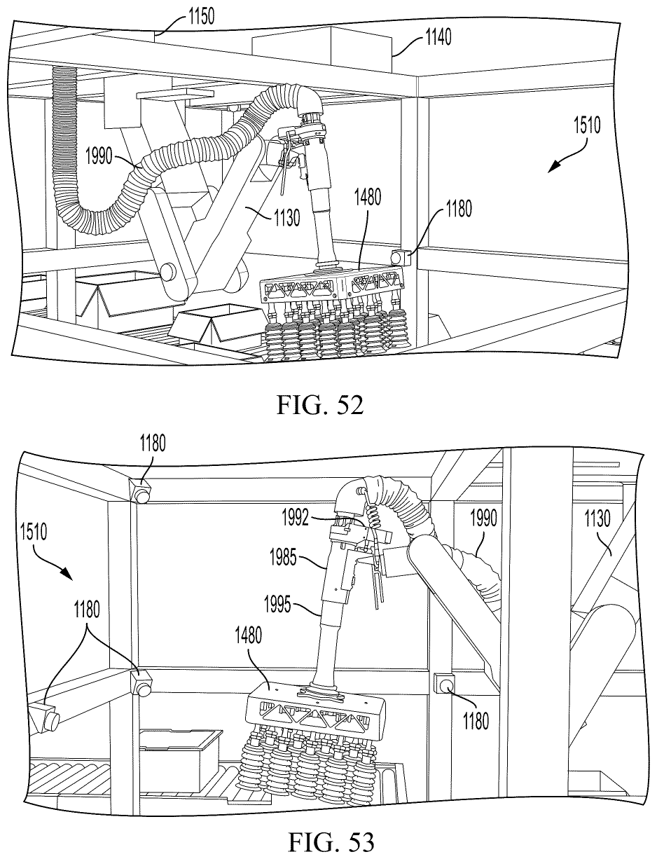

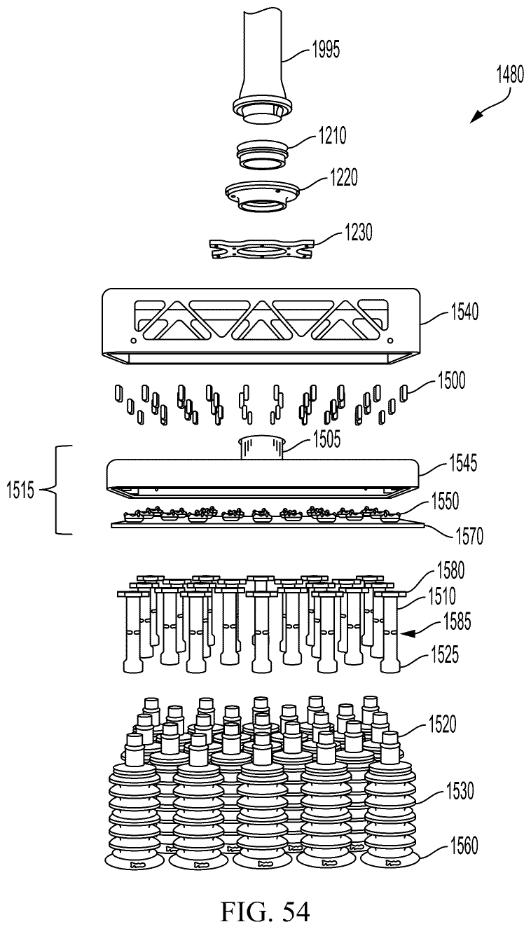

With reference to FIG. 52 the alternative force sensing array end-effector 1480 is shown at the object processing station 1510. Similarly, the object processing station 1510 includes perception systems 1180 that provide guidance to the programmable motion device 1130, visual verification, and object identification. As shown in FIG. 53, the high flow vacuum source 1150 provides vacuum to the alternative force sensing array end-effector 1480 through vacuum hose 1990 and yawing adjustment through rotation of the alternative force sensing array end-effector 1480 by motor 1992. The programmable motion device 1130 is shown in a lifted position in that the alternative force sensing array end-effector 1480 is moving to grasp an object. In this lifted position, it is clear that the vacuum hose 1990 will induce tension on the programmable motion device 1130 if it were conventionally attached directly to the alternative force sensing array end-effector 1480. As will be described below in further detail with reference with FIGS. 54-58, the alternative force sensing array end-effector 1480 isolates the weight and sensing function from any deflections applied to the programmable motion device 1130, whether from movement of the programmable motion device 1130 or dynamic forces induced by the vacuum hose 1990 as the grasp becomes effective causing the vacuum pressure to change and vacuum flow to drop.

FIG. 53 shows a rear view of the programmable motion device 1130 of object processing station 1510 showing the mounting apparatus 1985 that couples the vacuum hose 1990 to the alternative force sensing array end-effector 1480 and the programmable motion device 1130. As described in more detail below with reference to FIGS. 54-58, the alternative force sensing array end-effector 1480 is cooperatively mounted to a vacuum tube 1995 that is coupled to the vacuum hose 1990 where the vacuum tube 1995 is slidably engaged in the mounting apparatus 1985, and coupled to the force sensing array end-effector 1120. The vacuum tube 1995 is movable with respect to the mounting apparatus 1985 to provide a slidable engagement when the alternative force sensing array end-effector 1480 makes contact with an object, and rotates the vacuum tube 1995 and the alternative force sensing array end-effector 1480 in a yawing motion by actuation of the motor 1992. As shown at FIG. 53, the vacuum tube 1995 fully extends from the mounting apparatus 1985 when the grasp is made and the programmable motion device 1130 extracts the grasped object from its pick location, thereby permitting the alternative force sensing array end-effector 1480 to perform a weight and torque detection and assessment.

As the articulated arm of the programmable motion device 1130 is extended, the vacuum hose 1990 will also be extended, which will impact the dynamic forces applied to the programmable motion device 1130, particularly at the end-effector joint 1965, where typical force measurements are made to establish the weight of the picked item and torque applied to the programmable motion device 1130. As will be described in further detail below with reference to FIGS. 54-58, the alternative force sensing array end-effector 1480 isolates the weight and torque sensing functions of the end-effector from the programmable motion device 1130 and the ancillary equipment to provide an accurate and reliable assessment of the weight of the object grasped.

FIG. 54 shows an exploded view of the alternative force sensing array end-effector 1480 to show the internal mechanisms that provide weight sensing with an array of vacuum cups 1560 with greater resolution with each of the array of vacuum cups providing a force measurement, from which a force and/or torque on the alternative force sensing array end-effector 1480 can be assessed. The vacuum tube 1995, as described with reference to FIG. 53, is rigidly attached to the outer body 1540 by a mounting coupling 1220 and a mounting plate 1230 so that the outer body 1240 does not rotate relative to the vacuum tube 1995. As noted with reference to FIG. 53, a yawing motion of the alternative force sensing array end-effector 1480 is induced by rotation of the vacuum tube 1995. A vacuum coupling 1210 provides a vacuum seal to the environment at the mounting position of the vacuum tube 1995 to the outer body that is fluidically routed to an inner cover 1545 through a vacuum port 1505.

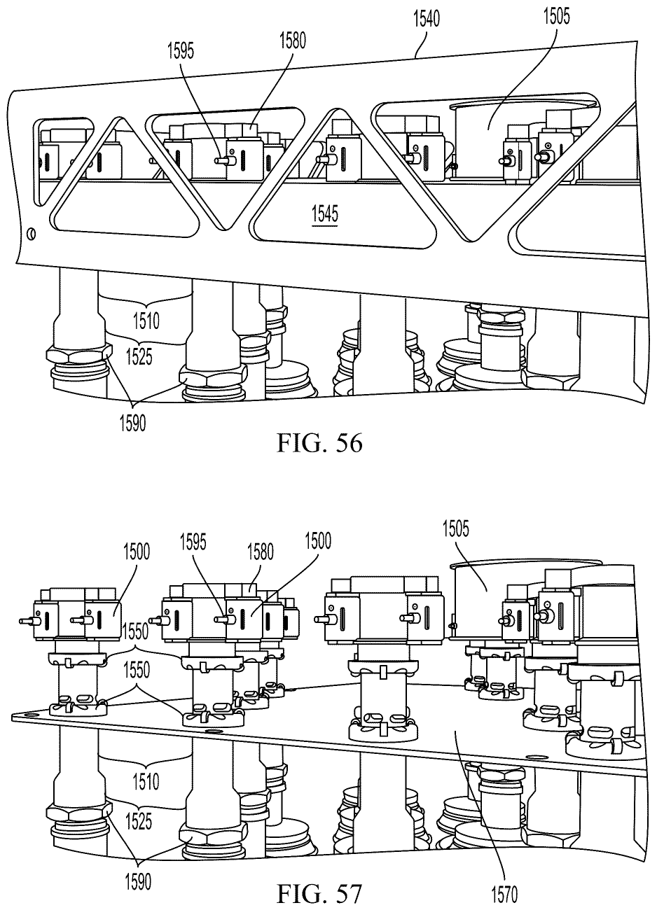

The inner cover 1545 and a bottom plate 1570, when coupled to the high flow vacuum supply 1150, form a vacuum chamber 1515, rigidly attached to the outer cover 1540, and therefore, the vacuum tube 1995. The array of suction cups 1560, each having a bellows 1530 are attached at a proximal end 1520 to a distal end 1525 of the vacuum rods 1510 that pass completely through the bottom plate 1570 and the inner cover 1545. Each of the vacuum rods 1510 have a tab feature 1580 on the proximal end that, when assembled, include a pair of force sensors 1500 (e.g., load cells or force torque sensors) between the tab feature 1580 and the top surface of the inner cover 1545. Vacuum sealing bearings 1550 are positioned on the bottom plate 1570 and the top cover 1545 (shown in FIGS. 56 and 57) that permit the vacuum rods 1510 to slide freely and effectively transfers downward forces applied to the array of suction cups 1560 onto the top surface of the inner cover 1545 through the respective pair of force sensors 1500.

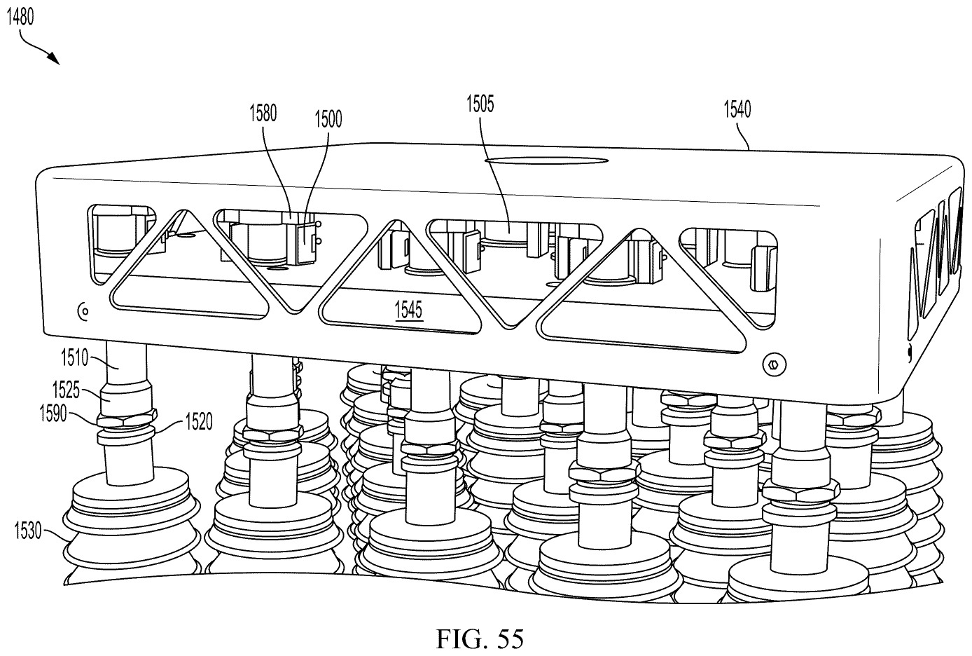

Each of the vacuum rods 1510 are hollow and open at the distal end 1525, and sealed at the proximal end at the tab feature 1580. Vacuum is routed from the vacuum chamber 1515 through vacuum ports 1585 and directly to the bellows 1530. FIG. 55 depicts the alternative force sensing array end-effector 1480 in assembled form, showing the distal end 1525 of a vacuum rod 1510 attached to the proximal end 1520 of the bellows 1530. A locknut 1590 is shown as a mechanism to ensure the vacuum rod 1510 is rigidly attached to the bellows 1530 so that forces transmitted by an object grasped thereon is transmitted to the vacuum rod 1510. The vacuum rod 1510 protrudes into and completely through the inner cover 1545 and arranged so that the tab feature 1580 captures the force sensor 1500 between it and the inner cover 1545.

FIG. 56 depicts the alternative force sensing array end-effector 1480 as shown in assembled form as in FIG. 55 from a slightly different perspective. In FIG. 55, the relative position of the force sensors 1500 are positioned between the tab feature 1580 of the vacuum rod 1510 so that forces transmitted by a grasped object grasped is transmitted to the force sensors 1500. Signal connector 1595 is shown with cabling removed for clarity.

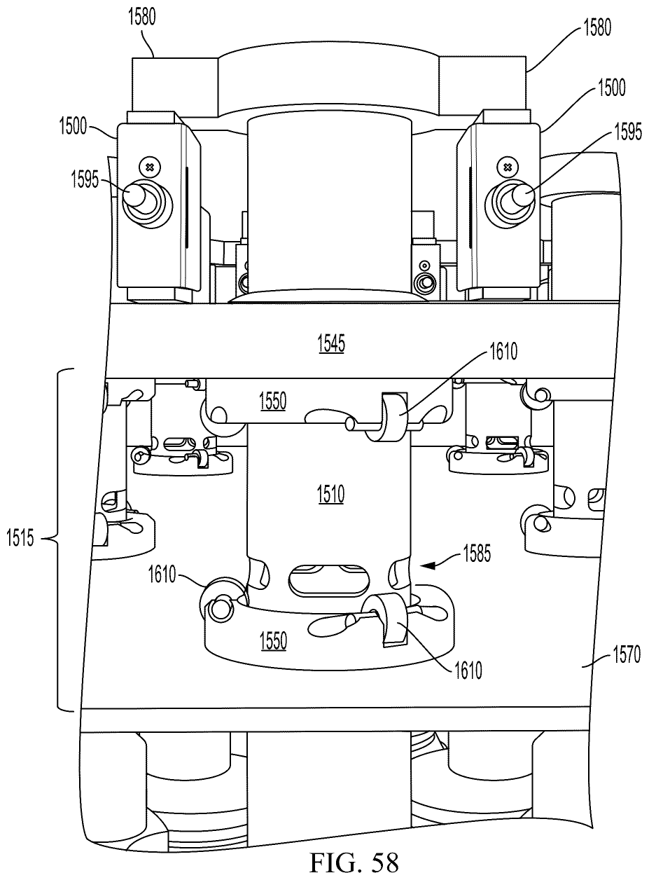

FIG. 57 depicts the same view of the alternative force sensing array end-effector 1480 as FIG. 56 but with the outer cover 1540 and the inner cover 1545 removed for clarity. As with FIG. 56, the relative position of the force sensors 1500 are positioned between the tab feature 1580 of the vacuum rod 1510 so that forces transmitted by a grasped object are transmitted to the force sensors 1500, which operate in compression. An alternative configuration can be fixtured, if necessary, to operate the force sensors 1500 in tension, by arranging the force sensors 1500 above the tab feature 1580 and adhering the force sensor thereon with appropriate fixturing to the inner cover 1545. Signal connector 1595 is shown with cabling removed for clarity. Inside the vacuum chamber 1515, the vacuum rod 1510 is supported by a pair of vacuum sealing bearings 1550 that minimize leakage of vacuum to the environment yet minimize friction or drag so that the vacuum rod can transmit forces applied to it from a grasped object directly to the force sensors 1500. FIG. 58 shows an enlarged cross-sectional view of the vacuum chamber 1510 formed by the inner cover 1545 and the bottom plate 1570 with the vacuum sealing bearings 1550 supporting the vacuum tube 1510 with vertically translational bearings 1610 permitting the vertical translation of the vacuum tube 1510 while supporting and resisting horizontally-applied forces. The vacuum tubes 1510 are free to lift from the force sensors 1500 with gravity biasing the position of the tab features 1580 on the force sensors 1500. Optionally, a spring bias (not shown) can be provided with springs positioned between the proximal end of the vacuum tubes 1510 and the underside of the outer cover 1540. The relative location of the vacuum ports 1585 remain within the vacuum chamber 1515 region despite vertical translation of the vacuum tubes 1510 so that high flow vacuum from the vacuum supply 1150 is readily available to the bellows 1530 and the array of suction cups 1560.

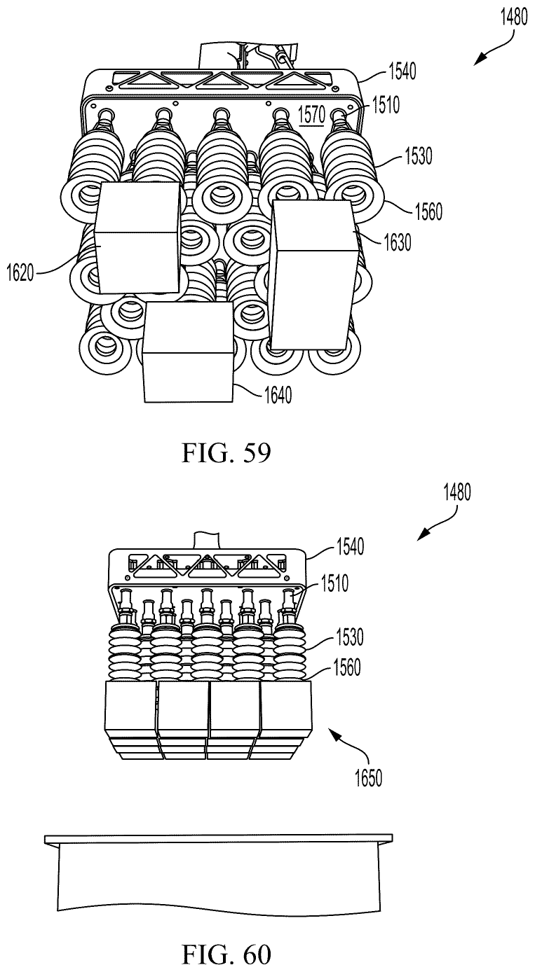

The plurality of force sensors are configured to provide a spatial force distribution usable to detect single-object or multi-object grasps and to estimate a center of mass of the one or more engaged objects while maintaining vacuum delivery to the suction elements. FIG. 59 depicts the alternative force sensing array end-effector 1480 in operation with a multiple-object grasp, where a first object 1620 is grasped by a plurality of the array of suction cups 1560, including partially-obscured suction cups 1560. A second object 1630 is similarly grasped by a plurality of the array of suction cups 1560, including partially obscured suction cups. A third object 1640 is similarly grasped. Signals from the corresponding force sensors associated with the tab features of the vacuum rods 1510 transmitting the grasping force thereon are assessed by the processor 1140 of the object processing station 1510 that can establish that a multiple-object grasping condition exists. Additionally, as described above, the distribution of forces that are measured by the force sensors can be used to establish a center of mass for each of the grasped objects 1620, 1630, and 1640 and identified with reference to perception data from the perception devices 1180 of the object processing station 1510.

FIG. 60 depicts further capabilities of the alternative force sensing array end-effector 1480 with grasping an array of objects 1650 with force assessment performed upon the signals from force sensors 1500 corresponding from forces transmitted from each of the vacuum tubes 1510 in response to the object(s) grasped by the array of suction cups 1560. The force sensing end-effectors of FIGS. 51-60 provide movement of the first portion with respect to the second portion while also providing that the vacuum chamber is maintained at substantially constant volume during such relative movement.

Those skilled in the art will appreciate that numerous modifications and variations may be made to the above disclosed embodiments without departing from the spirit and scope of the present invention.

What is claimed is:

1. A force sensing end-effector comprising:
a first portion connected to a vacuum cup that is movable axially with respect to a second portion that is coupled to a programmable motion device and through which a vacuum is provided in a vacuum chamber that is maintained at a substantially constant vacuum volume irrespective of movement of the first portion with respect to the second portion; and
at least one force sensor that is positioned to be impacted by movement of the first portion with respect to the second portion and to provide information relating to a force on the first portion with respect to the second portion.

2. The force sensing end-effector of claim 1, wherein the vacuum is a high flow vacuum and is provided to the first portion through at least one side opening along a wall of the first portion.

3. The force sensing end-effector of claim 2, wherein the vacuum chamber is partially defined by upper and lower rolling diaphragms.

4. The force sensing end-effector of claim 1, wherein the vacuum chamber is partially defined by at least two pressure-balanced bellows units.

5. The force sensing end-effector of claim 4, wherein the vacuum chamber is partially defined by three bellows units that are positioned between four plates.

6. The force sensing end-effector of claim 1, wherein the vacuum chamber is partially defined by an upper flange and a lower flange that capture the at least one force sensor therebetween.

7. The force sensing end-effector of claim 1, wherein the vacuum chamber is partially defined by a plurality of vacuum cups that are arranged in an array-based configuration.

8. A force sensing end-effector comprising:
a first portion coupled to at least one vacuum cup and a second portion coupled to a programmable motion device;
a central passage extending through the second portion to the first portion and fluidically connectable to a vacuum source for delivering a vacuum to at least one vacuum cup; and
at least one force sensor disposed between the first portion and the second portion, wherein the at least one force sensor is adapted to provide information relating to force on the first portion relative the second portion.

9. The force sensing end-effector of claim 8, wherein the at least one force sensor is provided among a plurality of force sensors around a central passage through which vacuum is provided to the at least one vacuum cup.

10. The force sensing end-effector of claim 9, wherein the gap between the first portion and the second portion is a precision slip fit sized to reduce frictional resistance without significantly increasing vacuum leakage.

11. The force sensing end-effector of claim 9, wherein the plurality of force sensors are arranged symmetrically around the central passage to enable differential readings for determining torque and/or center-of-gravity.

12. The force-sensing end-effector of claim 9, wherein the plurality of force sensors are arranged in an array and the at least one vacuum cup is provided among a plurality of vacuum cups.

13. The force sensing end-effector of claim 12, wherein each vacuum cup is associated with at least one of the plurality of force sensors.

14. A torque sensing end-effector for a programmable motion device, comprising:
a first portion coupled to at least one vacuum cup that is movable axially with respect to a second portion that is coupled to a programmable motion device and through which a vacuum is provided to the at least one vacuum cup via a vacuum passage; and
a plurality of force sensors that are positioned around the vacuum passage, the plurality of force sensors being adapted to provide information relating to applied torque on the first portion relative the second portion.

15. The torque sensing end-effector of claim 14, wherein the first portion includes a lower flange, the second portion includes an upper flange, and wherein the plurality of force sensors is positioned between the upper and lower flanges.

16. The torque sensing end-effector of claim 14, wherein the at least one vacuum cup is provided among a plurality of vacuum cups.

17. The torque sensing end-effector of claim 16, wherein the outputs of the force sensors are processed to detect multiple-object grasp conditions.

18. The torque sensing end-effector of claim 16, wherein the plurality of vacuum cups are provided in an array-based configuration.

19. The torque sensing end-effector of claim 16, wherein the plurality of force sensors are provided outside of the vacuum passage.

20. The torque sensing end-effector of claim 16, wherein each of the plurality of vacuum cups is associated with at least one force sensor of the plurality of force sensors.
